(19) United States
(12) Patent Application Publication
(10) Pub. No.: US 2007/0078725 A1
(43) Pub. Date: Apr. 5, 2007

(54) INTEGRATED CUSTOMER FULFILLMENT MANAGEMENT

(75) Inventors: William J. Koszewski, Kirkland, WA (US); Jeremy R. Whiteley, Kirkland, WA (US); James E. Perkins, Bangkok (TH); Travis Ortlieb, Seattle, WA (US)

Correspondence Address: LEE & HAYES, PLLC, 421 W. RIVERSIDE AVE, STE 500, SPOKANE, WA, 99201, US

(73) Assignee: Marketsync, Inc., Kirkland, WA (US)

(21) Appl. No.: 11/469,846

(22) Filed: Sep. 1, 2006

Related U.S. Application Data
(60) Provisional application No. 60/715,465, filed on Sep. 9, 2005.

(51) Int. Cl. G06Q 30/00

(52) U.S. Cl. 705/26

(57) ABSTRACT

An integrated customer fulfillment management (ICFM) system allows a user to request a fulfillment package to be delivered to a recipient using a computing system. The fulfillment request, specifying personal information about the recipient is specified. The content of the fulfillment package is selected, which may include a communication personalized to the recipient, such as a letter, an e-mail, a link to a personalized web page, or other content. The content of the fulfillment package also may include one or more documents, such as literature regarding a good or service, or an article, such as a gift or another item requested or needed by the user. The fulfillment request is directed to a fulfillment center for preparation of the fulfillment package. The fulfillment center is able to access personal information about the recipient to generate the personalized letter, prepare the fulfillment package, and facilitate shipping of the fulfillment package.

### PRIORITY CLAIM

This application claims the priority of provisional patent application Ser. No. 60/715,465, filed Sep. 9, 2005, for “INTEGRATED CUSTOMER FULFILLMENT MANAGEMENT.” Priority is hereby claimed to this case under 35 U.S.C. section 120.

### BACKGROUND

Although the proliferation of the Internet and on-line sales has affected how millions of people buy goods and services, effective marketing of goods and services still relies on many traditional techniques. For example, if as part of an outbound marketing campaign, in response to a client contact, or other promotional activities, a prospective client requests product literature or a quote for a service, a good salesperson will promptly send that literature or quote to the prospective client with a personalized letter to show the seller's interest in the client. Also, if a current customer should refer one or more additional customers to the seller, the seller should send a personalized letter to the current customer to thank him or her for the referral. In addition, when a customer places a large order, has remained a loyal customer for a long period of time, and at holidays, sellers may want to send a gift to show appreciation. Preferably, the gift carries the logo of the seller to keep the business's name where the customer and others who might interact with or visit the office of the customer can see it, to provide further advertising for the seller.

Providing effective customer service, of course, extends beyond the sales context. For example, a customer may purchase an item from a manufacturer to find that the item was shipped without a part or with a defective part, or that the item was not packed with appropriate instructions or other documentation. To provide good customer service, the manufacturer should appropriately apologize to the customer, and provide replacement documents or parts as quickly as possible.

The sending of these letters, documents, and articles, are all part of what is termed “fulfillment,” which is a very important aspect of many businesses. Unfortunately, effectively managing customer fulfillment to maintain customer relationships often proves to be surprisingly difficult, time-consuming, or wasteful. Even to send a short, form-based letter, the customer's name, address, and other information must be entered, the letter must be printed on appropriate letterhead, and the letter must be mailed in a timely fashion. Even if the seller maintains the customer information in a computer database, exporting this information to a word processing system may be time-consuming or cumbersome. Further, if a particular piece of literature is to be provided with the letter, if copies of the literature are available, the appropriate literature must be identified, retrieved, and included with the letter. When it is appropriate to send physical merchandise, such as products, parts, or promotional gifts, the sender must maintain a sufficient stock of physical merchandise on-hand, or must order appropriate physical merchandise for the sender. Thus, all of these gestures cost money and consume time.

Large companies may employ a person or a staff of people just to perform customer fulfillment duties. The salaries, benefits, and overhead for such persons involve a significant cost. For sole proprietors or small businesses that cannot dedicate one or more people to such jobs, personnel must take time away from working with other customers or performing other tasks to perform customer fulfillment. Furthermore, the business must maintain a stock of needed supplies, such as letterhead, brochures, and gifts. Unfortunately, if a business allocates too many boxes of letterhead, brochures, or logo-bearing gifts to one office or salesperson, and logos are changed or the information in the brochures becomes out of date, these documents and items go to waste. Even more unfortunately, while one office or salesperson is discarding a surplus of out-of-date materials, if the business failed to allocate enough letterhead, brochures, or gifts to another office or salesperson, that office or salesperson will not have enough customer fulfillment supplies.

One exemplary industry in which customer fulfillment is very important, and its problems are both manifest and acute, is the insurance industry. The insurance industry relies heavily on personal relationships between its insurance agents and their clients. Agents depend on their customers' loyalty for policy renewals and for referrals of other potential clients. Thus, managing customer fulfillment is very important to insurance companies.

In addition, insurance commonly is sold by individual agents, each of whom runs his or her own agency. Managing customer fulfillment in sending letters, literature, quotes, and gifts takes away time they need to be spending on selling to new customers. To these small agencies, maintaining an appropriate inventory of letterhead, brochures, and gifts both represents a considerable expense. Maintaining such an inventory also consumes valuable storage space of which the agency may have little to spare. Moreover, if one agency orders more letterhead, brochures, and gifts than it can use, at the same time, another agency may not be able to obtain the supplies it needs to manage its own customer relationships.

For all these concerns, being prepared for and managing customer fulfillment is only one part of the problem with customer fulfillment. Sending a letter, a brochure, a quote, or a gift may just be the first step in a marketing effort. A salesperson may wish to or need to follow up with a prospective customer regarding the information or items sent. It would be highly desirable for a salesperson to be able to track when items were delivered, or at least when they were sent, to know when to follow up with the customer. After all, if the salesperson should call to follow up on an item that has not yet been sent, the salesperson has wasted his or her time, been made to look foolish, and, perhaps worst of all, has called attention to possible deficiencies in his or her company's customer service abilities. On the other hand, it also is a problem if the salesperson waits too long to follow up with the customer. The customer may have forgotten what was sent, lost interest in the transaction, or been wooed by a competitor during the intervening time.

A still larger problem remains. In managing customer fulfillment in a reflexive, ad hoc manner by sending correspondence and other items on an as needed basis, a person participating in the fulfillment process may have no idea whether sending the correspondence and other items has resulted in a worthwhile return on investment. A seller may choose to invest time in logging the names of customers to whom letters, brochures, and other items have been sent. However, even in tracking such information, whether in the customer's file or in a general log, it would involve even more effort to then attempt to correlate the tracking information with sales information to attempt to correlate whether there was any positive return on the seller's customer fulfillment effort.

### SUMMARY

An integrated customer fulfillment management (ICFM) system allows a user to request a fulfillment package to be delivered to a recipient using a computing system. The fulfillment request, specifying personal information about the recipient is specified. The content of the fulfillment package is selected, which may include a communication personalized to the recipient, such as a letter, an e-mail, a link to a personalized web page, or other content. The content of the fulfillment package also may include one or more documents, such as literature regarding a good or service, or an article, such as a gift or another item requested or needed by the user. The fulfillment request is directed to a fulfillment center for preparation of the fulfillment package. The fulfillment center is able to access personal information about the recipient to generate the personalized letter, prepare the fulfillment package, and facilitate shipping of the fulfillment package.

Personal information about the recipient can be supplied or retrieved from a customer relationship management system. Information about the fulfillment package is made available regarding preparation, shipment, transit, and delivery of the fulfillment package. The personal information may include one or more of the name of the recipient, the recipient's address, the recipient's e-mail address, the recipient's title, a salutation appropriate to the recipient, the name of at least one additional person associated with the recipient, a designation of an occasion motivating the fulfillment request a name of a person requesting the fulfillment package or on whose behalf the fulfillment package is requested, a signature of the person requesting the fulfillment package or on whose behalf the fulfillment package is requested, and promotion information identifying actions to be undertaken for the recipient including specifying contents of at least one predetermined fulfillment package to be sent to the recipient.

In one embodiment, the fulfillment package is requested using a computing system, with the fulfillment package actually being created by one or more persons at a fulfillment center. In another embodiment, the fulfillment package may include a communication and/or physical merchandise that is prepared and shipped without human intervention. Once the fulfillment package is shipped, information from the shipping company is received by the ICFM system for tracking by the user. When the ICFM system is coupled with a customer relationship management (CRM) system, the ICFM system can access and update information stored in the CRM system, and the reporting and analysis tools of the CRM system can be used to analyze fulfillment event data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a three-digit reference number identifies the figure in which the reference number first appears, and the two left-most digits of a four-digit reference number identifies the figure in which the reference number first appears. The use of the same reference numbers in different figures indicates similar or identical items.

FIG. 1 is a network diagram of an embodiment of integrated customer fulfillment management (ICFM) system.

FIG. 2 is a flow diagram illustrating logical operational steps of an embodiment of ICFM.

FIG. 3 is a flow diagram illustrating the logical steps of selecting a fulfillment operation.

FIG. 4 is a login screen of an ICFM system.

FIG. 5 is an initial option screen presented according to a mode of an ICFM system.

FIG. 6 is a flow diagram illustrating the logical steps of processing a fulfillment request.

FIG. 7 is a fulfillment request selection screen presented according to a mode of an ICFM system.

FIG. 8 is an information entry screen used to customize a fulfillment package.

FIG. 9 is an enclosure selection screen allowing a user to select enclosures to complete a fulfillment package.

FIG. 10 is a preview screen for reviewing correspondence generated by an ICFM system.

FIG. 11 is an order confirmation screen presented according to a mode of an ICFM system.

FIG. 12 is an exemplary e-mail inbox screen including entries representing confirming e-mails reporting fulfillment events.

FIGS. 13-15 are e-mail screens confirming the ordering, shipment, and delivery of a fulfillment package requested by a user.

FIG. 16 is a flow diagram illustrating the logical steps of processing an order history request according to a mode of an ICFM system.

FIG. 17 is an order history reported generated by an ICFM system.

FIG. 18 is a network diagram of an embodiment of an ICFM system in communication with a customer relationship management (CRM) system.

FIG. 19 is a flow diagram illustrating logical operational steps of an embodiment of an ICFM system in communication with a CRM system.

FIG. 20 is a login screen of a CRM system in communication with an ICFM system.

FIG. 21 is an initial option screen of a CRM system showing an option to select ICFM functions.

FIG. 22 is a fulfillment request selection screen presented by a CRM system in communication with an ICFM system.

FIGS. 23-24 are information entry screens presented by a CRM system coupled with an ICFM system.

FIG. 25 is a block diagram of a computing-system environment suitable for use in hosting and/or interacting with ICFM with or without an integrated CRM.

### DETAILED DESCRIPTION

In a mode of an ICFM system, a user can generate and send customer fulfillment packages, including personalized communications, including correspondence, documents, e-mails, links to personalized web pages, and/or articles, from a computer-accessible service. In one mode of an ICFM system, the fulfillment packages are prepared and sent from a fulfillment site, freeing the user of having to store appropriate inventory, prepare the fulfillment packages, and ship the fulfillment packages. Furthermore, a user can track when fulfillment packages are ordered, shipped, and/or received, allowing the user to contact the recipient for timely follow-up discussions. Also according to a mode of an ICFM system, a customer relationship manager or another customer management system is in communication with an ICFM system, allowing ICFM functions to be accessed through the CRM system and to include the fulfillment event information in the CRM system for further analysis.

Using ICFM not only simplifies, centralizes, streamlines, and/or expedites the customer fulfillment process, but also allows ICFM users to take better advantage of customer fulfillment opportunities. According to a mode of ICFM, a person, such as an agent of an insurance company or any other salesperson, can generate customized letters to customers that are appropriate for a wide range of customer relations events merely by providing the information regarding the customer and the event via an interface screen. Moreover, if one or more components or enclosures of the fulfillment package, such as brochures, literature, merchandise, parts, or promotional gifts, are to be included with a communication, the agent selects the component(s) or enclosure(s) from an additional screen, thus simplifying the customer fulfillment process. Alternatively, the person may be a customer service representative for a manufacturing company who assists customers who have received a product without an instruction manual, or that was shipped with a missing or defective part. The person can generate a fulfillment package including a personalized letter of apology, a manual, and/or a replacement part.

According to one mode of an ICFM system, fulfillment packages, including personalized communications, correspondence, documents, and/or articles, are sent from a fulfillment site where fulfillment processes are centralized. The fulfillment site can be maintained within an organization or outsourced to a third-party fulfillment service. The fulfillment site stocks letterhead for managing customer fulfillment through the central site, as well as maintaining a stock of documents and/or articles that the users wish to send to customers and other contacts or support the capability to generate such documents or articles on demand. Correspondence is printed on appropriate letterhead and, according to one mode of an ICFM system, bears a reproduced signature of the user. Enclosures, including documents and/or articles, are included with the correspondence and shipped from the central site. In addition, when customer fulfillment is outsourced to a third-party service, separate inventories for each of the third-party service's clients can be maintained for each client without any of the clients having to support the infrastructure and bear the overhead of maintaining its own in-house fulfillment department.

Moreover, an ICFM system also streamlines the process of customer fulfillment. Because inventories of letterhead, documents, and/or articles are maintained at a central site, users need not maintain separate, duplicative inventories. Further, because fulfillment packages for multiple users are generated from a central site, users needing more documents and/or articles will have access to inventories they need, without having to provide space to store that inventory. Correspondingly, users needing fewer documents and/or articles will not have to pay for inventory or storage space for inventory they may not use, and that might eventually go to waste if the documents or articles become out-of-date before they are used. Thus, individual users need not maintain separate inventories of letterhead, documents, and/or articles for fulfillment purposes. Furthermore, costs of the documents, articles, and even postage can be tracked and charged to the appropriate user for appropriate cost allocation.

In addition, an ICFM system expedites the customer fulfillment process. Because the sending of correspondence, documents, articles, and other items often is tedious and takes away time that might better be devoted to other tasks, customer fulfillment tasks frequently are put off until after other tasks. Furthermore, some businesses are never able to allocate an adequate staff or budget to perform appropriate customer fulfillment. Because an ICFM system makes it quick and easy to direct the sending of fulfillment packages, users will be better able and more willing to send fulfillment packages in a timely fashion.

Finally, an ICFM system also allows users to take better advantage of customer fulfillment opportunities. According to a mode of an ICFM system, users are informed of when fulfillment packages are ordered, shipped, and/or delivered. In one mode, an ICFM system receives information from or interfaces with a shipping company's tracking system to relay the shipping status of fulfillment packages. Thus, a user wanting to contact a customer when the customer has just received correspondence, documents, or an article can call the customer when the information or goodwill is fresh in the customer's mind. In addition, in a mode of an ICFM system where the ICFM system is in communication with a CRM system, information about fulfillment events can be stored in the CRM system database. With the fulfillment data stored in the CRM system database, CRM system reporting and analysis tools can be used to analyze the effectiveness of sending correspondence, documents, and/or articles in making decisions about how to handle future customer fulfillment opportunities.

In the exemplary embodiments described in the remainder of the specification that follows, the fulfillment packages include a communication manifested in a letter or other physical document, which may be combined with a physical article. However, one should note that the fulfillment package may not include tangible, physical contents. For example, the fulfillment package may include an electronic communication, such as an e-mail or other electronic document. Moreover, additional content may include additional electronic documents, or a link to a web page, which may be personalized for the recipient of the fulfillment package. As a result, the fulfillment centers and shipping companies described below may include facilities for the preparation of electronic documents, and the facilities for transmitting or otherwise available the contents of the electronic documents.

Overview of an Integrated Customer Fulfillment Management

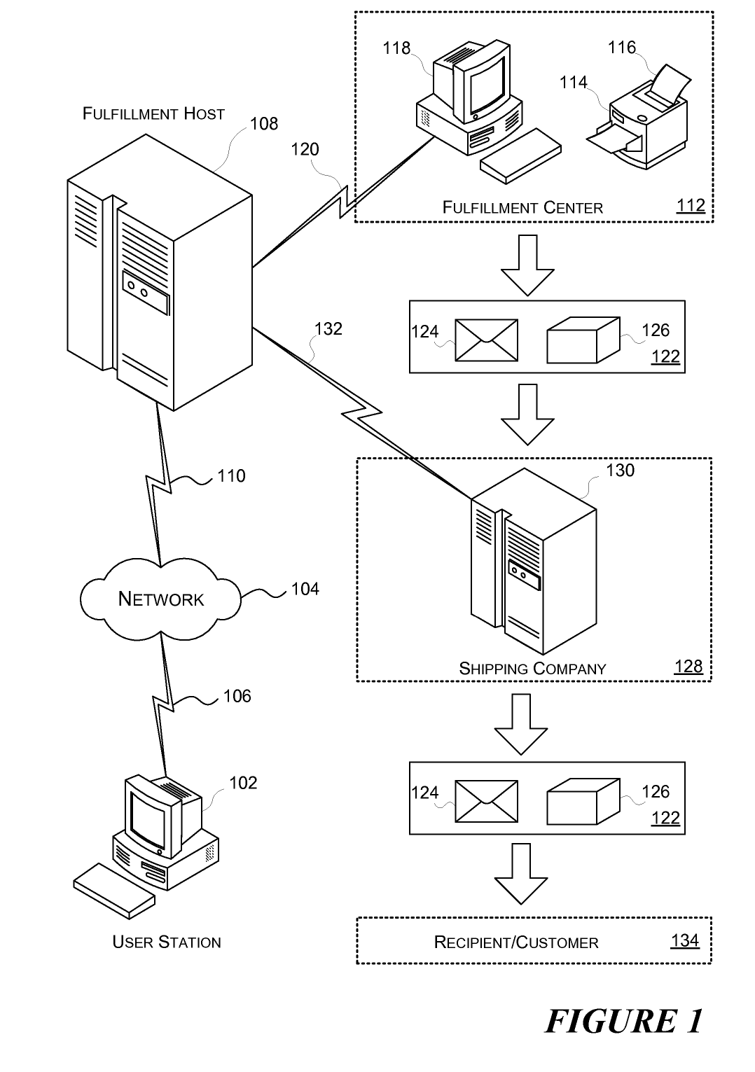

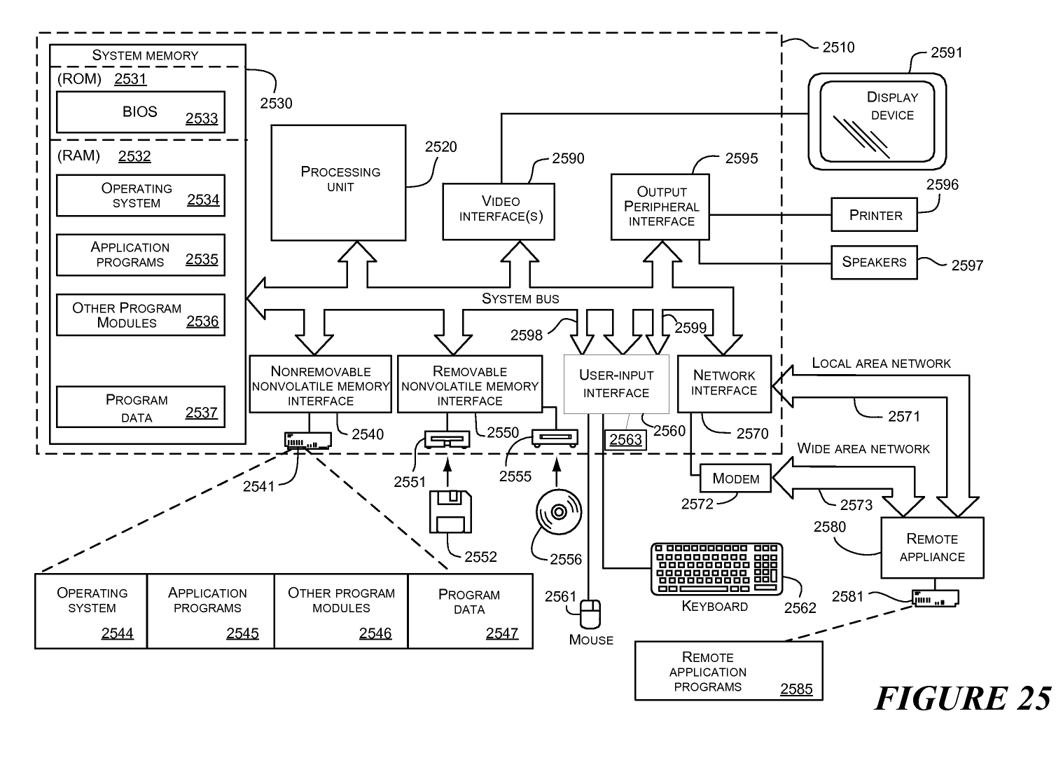

FIG. 1 illustrates aspects of an ICFM system 100. A user (not shown) accesses the ICFM system 100 using a user station 102. The user station 102, as will be described further below in connection with FIG. 25, may include a desktop computer, laptop computer, handheld computer, a terminal, or a similar device that allows the user to access an ICFM application. The user station 102 is coupled to a network 104, such as a local area network (LAN), or a wide area network (WAN) such as the Internet or another WAN, via a communications link 106. In turn, the network 104 communicates with a fulfillment host 108 via an additional communications link 110. The fulfillment host 108 may be a personal computer, a server, a mainframe computer, or a group of such computers. The communications links 106 and 110 may include dial-up, Ethernet, broadband, wireless, or other forms of communication providing data communications. To name one example described further below, a user may access a fulfillment application running on the fulfillment host 108 from a web browser executing on the user station 102.

Once a user enters a fulfillment request at the user station 102, on behalf of himself or herself or on behalf of another person, the fulfillment host 108 processes the fulfillment transaction and generates a fulfillment order to be processed by a fulfillment center 112. According to one mode of an ICFM system, fulfillment orders are stored in a cache or a database until they are processed. When the fulfillment orders are stored in a database, fulfillment orders can be processed when sufficient staff is available to complete the fulfillment packages. Moreover, when fulfillment orders are stored in a cache or database instead of being issued on a first-in-first-out basis, fulfillment personnel can, aggregate the fulfillment orders for a particular client. Aggregating orders for a particular client allows the fulfillment personnel to work with one inventory of letterhead, documents, and/or articles at one time. Being able to work with one inventory at a time simplifies the work of the fulfillment personnel and helps to prevent errors that might result if fulfillment personnel constantly were switching between the inventories of multiple clients.

The fulfillment center 112, in one mode of an ICFM system, includes a printer 114 that is used to generate documents 116 including picking orders, correspondence, and customized documents, and a computer station 118 where processing of the fulfillment orders are confirmed. According to one mode of an ICFM system, the printer 114 supports graphics and/or color printing to reproduce signatures, generate on-demand letterhead styling, and provide similar functions.

In one mode of an ICFM system, when the fulfillment orders are processed, either upon issuance by the fulfillment host 108 or upon the fulfillment orders being retrieved from the cache or database, a picking order is generated. In addition, as described further below, storing the fulfillment orders in a cache or database also allows the user submitting the request the possibility of modifying or canceling the fulfillment request resulting in the order, if desired. In one mode, the picking order is generated as a document 116 at the fulfillment center 112. The picking order may specify which letterhead and how many sheets of that letterhead should be loaded into the printer 114 for generation of correspondence and any customized documents, and indicate whether a particular article is to be included in the fulfillment package. Using the picking order, fulfillment personnel can process the fulfillment order and prepare a fulfillment package 122, consisting of correspondence 124 and enclosures 126.

Fulfillment personnel use the computer station 118, which may be a personal computer, a terminal, or another device permitting access to the ICFM application on the fulfillment host 108, to signal when a fulfillment package has been prepared for shipment, or if there is a reason the fulfillment package cannot be sent. Alternatively, the picking order may be presented on the computer station 118 rather than in document form. The fulfillment station 112, including the printer 114 and the computer station 118 are in communication with the fulfillment host 108 via a communications link 120. The communications link 120 may be dial-up, Ethernet, broadband, wireless, or another form of communication providing data communications with the fulfillment host 108.

It should be noted that the fulfillment host 108 might reside at the fulfillment center 112. Thus, the fulfillment host 108 and the computer station 118 may be the same computing device. Alternatively, there may be multiple fulfillment centers 112 located at different geographic locations to serve customers in that geographic location or because fulfillment supplies are available in that particular geographic location. Further, a fulfillment center 112 may receive fulfillment orders from multiple fulfillment hosts 108. It should also be noted that, in another embodiment, the fulfillment package may include a communication and/or physical merchandise that is prepared and shipped without human intervention.

Once a fulfillment package 122 has been prepared, the fulfillment package is shipped. When a fulfillment package is entirely electronic in nature, such as consisting of an e-mail and or other electronic documents, the fulfillment package is sent electronically. On the other hand, when physical documents or merchandise are to be sent, the fulfillment package is sent using a shipping company 128 instead of a network or other transmission system adapted for the transmission of or presentation of electronic documents.

Fulfillment personnel may deliver fulfillment package 122 to the shipping company 128 or, using the computer station 118 or another means of communication, fulfillment personnel at the fulfillment center 112 inform the shipping company of one or more fulfillment packages 122 that are ready to be shipped. Once logged for shipment with or delivered to the shipping company 128, a shipping host 130 is used to track the delivery status of the fulfillment package 128. In one mode, the shipping host 130 communicates with the fulfillment host 108 via a communications link 132. The communications link 132 may include a dedicated line or be part of a WAN (not shown) such as the Internet, as previously described, over which data records are exchanged between the systems. The fulfillment host 108 may query the shipping host 130 for updates on the status of fulfillment packages 122 logged in the fulfillment host 108. Alternatively, the shipping host 130 may send updates to the fulfillment host 108 periodically or when specific events occur, such as the delivery of a fulfillment package 122 to a recipient or customer 134 or another recipient. Further alternatively, the shipping host 130 may send updates in the form of e-mail messages to the fulfillment host 108 or directing to a user so that the user may receive the updates at the user station 102 or via another computing system.

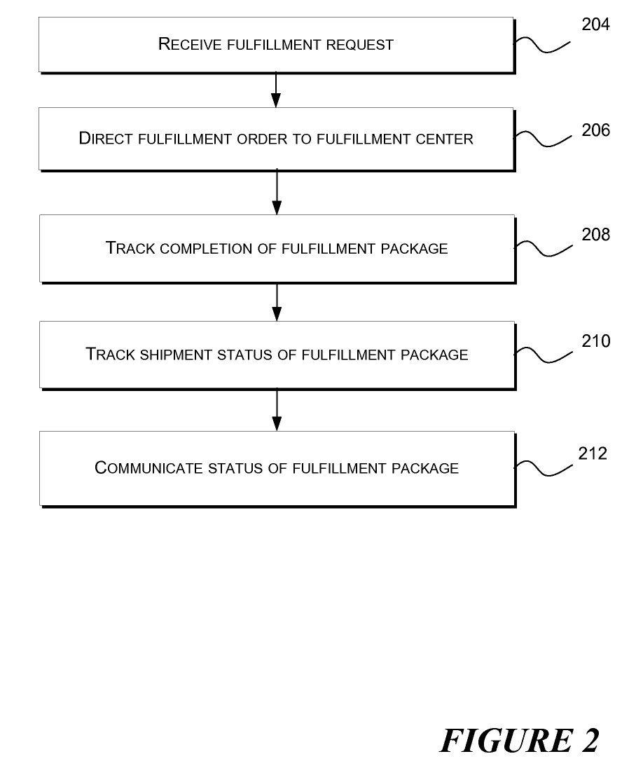

FIG. 2 includes a flow diagram of a process 200 summarizing a mode of ICFM. At 1204, a fulfillment request is received from a user, presumably using a user station 102 (FIG. 1). At 206, a fulfillment order is directed to a fulfillment center 112. At 208, completion of the fulfillment package is tracked. At 210, shipment status of the fulfillment package is tracked. At 212, the status of the fulfillment package is communicated, such as by e-mails to the user originating the fulfillment request, or by responding to order history inquiries, as described further below.

In sum, as described in FIGS. 1 and 2, entirely from a user's computer station, a user can cause a fulfillment package to be sent to a customer from a fulfillment station. The user will be informed or can determine when the fulfillment package has been delivered to the customer so that the user knows precisely when to follow up with the customer to make the most of the fulfillment opportunity.

User Services Provided by Integrated Customer Fulfillment Management

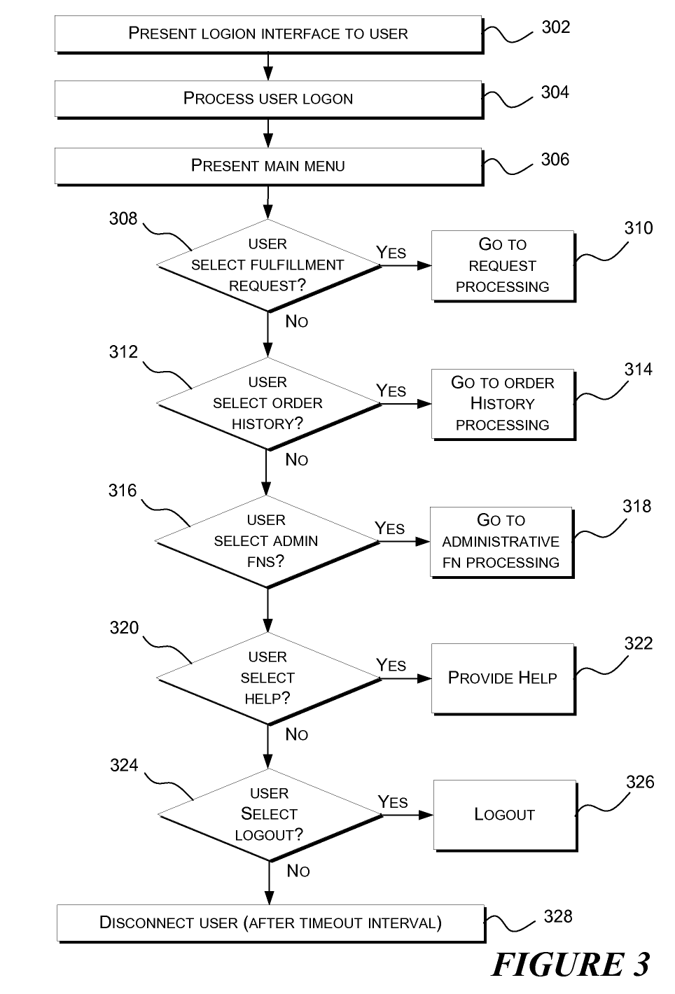

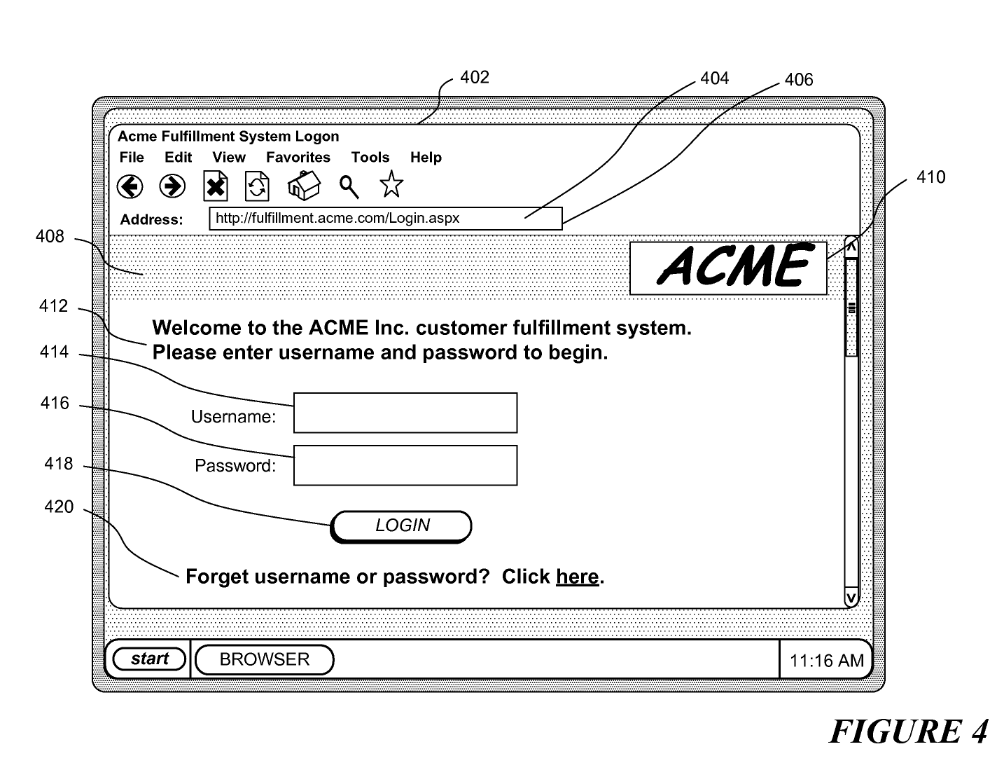

FIG. 3 is a flow diagram of a process 300 illustrating the logical steps of a mode of an ICFM process. At 302, a logon interface is presented to a user. The logon interface requests a user name and/or password from the user to prevent unauthorized persons from accessing the fulfillment system. In one mode, the ICFM process is facilitated by an application running on a web server or other host that is accessed via web pages presented to the user via a web browser, as shown in FIG. 4. In one such embodiment, data is generated for presentation and received from the user in the form of extended markup language (XML) code blocks that can be generated by an application, retrieved from a database, and rendered by a browser to present appropriate web pages. In addition, when a user submits a fulfillment request using a browser, XML code blocks that are generated can be processed by an application and/or stored in a database to create fulfillment orders.

Alternatively, the interface may be presented by an application executing on a user machine that is capable of directing fulfillment requests and exchanging fulfillment reporting information with one or more other computing systems to provide similar functions. In the latter form, because access to the application may be controlled by restricting access to the computing system, a logon screen may be bypassed.

FIG. 4 shows an exemplary logon screen 400 for a fulfillment system for the Acme Company. On screen 400, a browser application window 402 is presented. To access the fulfillment system, a user enters a uniform resource locator (URL) 404 of the fulfillment service in an address field 406. In one mode of ICFM and as shown in the URL 404, it is desirable that the URL 404 include the name of the company on whose behalf fulfillment services are being rendered. Thus, although the fulfillment services might be provided by a third-party fulfillment service instead of within the organization, it may be desirable that the URL reflect the name of the organization to corroborate the seamlessness of the ICFM service and to foster confidence in the third-party service. For similar reasons, even if the fulfillment service is provided by a third party, it may be desirable to customize the logon screen 400, for example, using a banner 408 presenting the logo 410 and colors used by the organization generally and/or on its own web page(s).

The logon screen 400 includes an instruction 412 to the user as to how to proceed. As is well understood, a user completes the logon process by entering a username in a username field 414 and a password in a password field 416. As is also well understood, the logon is completed by selecting a login button 418 with a cursor (not shown) or by the user pressing an enter key. The logon screen 400 also can include user help facilities, such as providing a forgotten username/password link 420 as presented on other web sites.

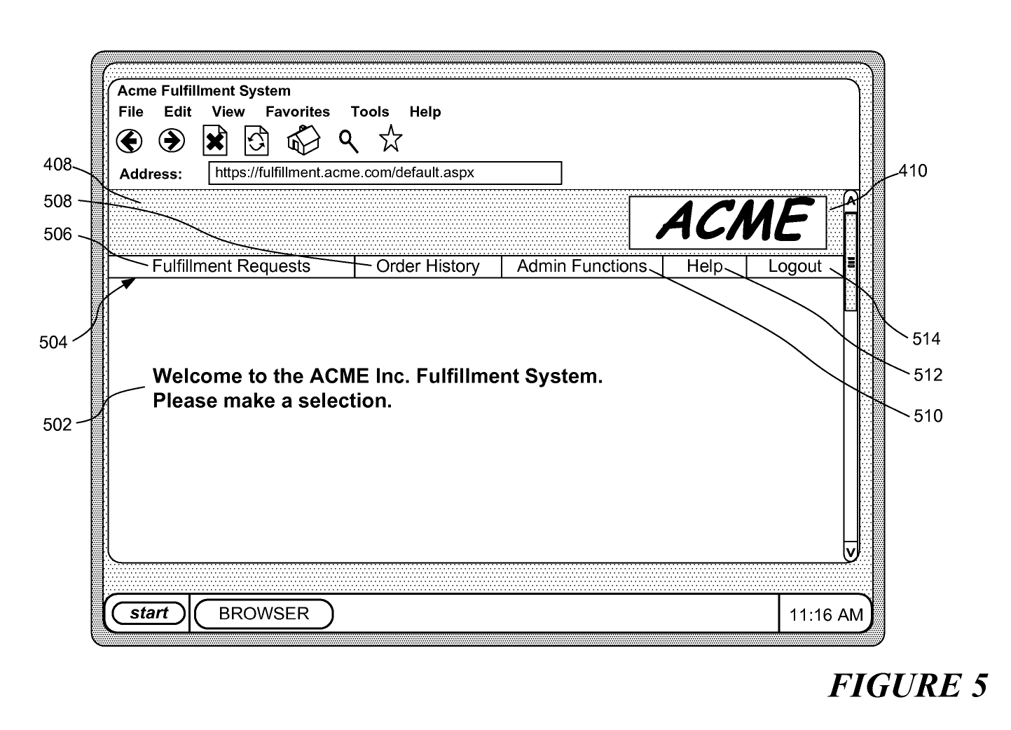

Referring to FIG. 3, once the user responds to the logon screen presented at 302, at 304, the user logon is processed to determine if the username and password presented are valid. Assuming the logon is successful, at 306, a main menu is presented to the user to allow the user to select a function that the user wishes to perform. Again, according to a mode of an ICFM process facilitated by an application executing on a web server or other host, a main menu is presented as a web page as shown in FIG. 5.

FIG. 5 shows an exemplary main menu screen 500. The main menu screen 500 preferably includes the same banner 408 and logo 410 presented on the logon screen 400 (FIG. 4) for the reasons previously described. In addition, the logon screen 500 presents an instruction 502 to the user to select an option from a menu 504. The menu 504 includes a plurality of options represented on-screen “buttons” selectable by a cursor. The menu 504 includes a fulfillment request option 506, an order history option 508, an administrative functions option 510, a help option 512, and a logout option 514. The administrative functions option 510 allows the user to change his or her password or e-mail address, and similar account functions that are well understood in transactional systems. Similarly, the help option 512 provides on-screen assistance to users, as also is well understood in such systems. Finally, the logout option 514 will terminate the user's ICFM session.

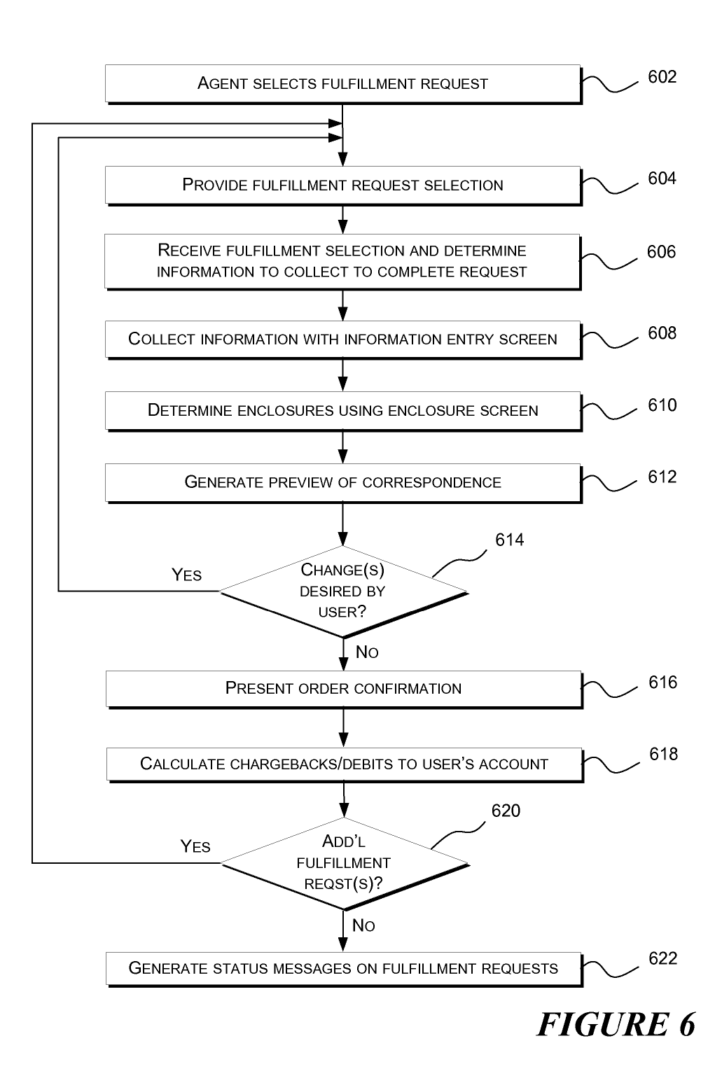

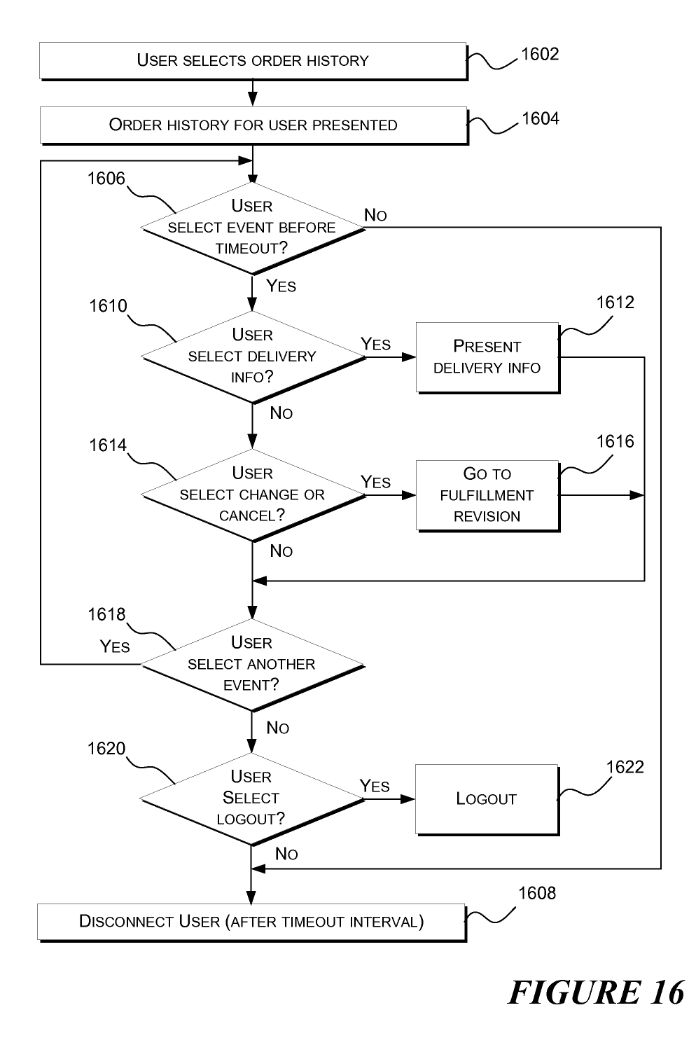

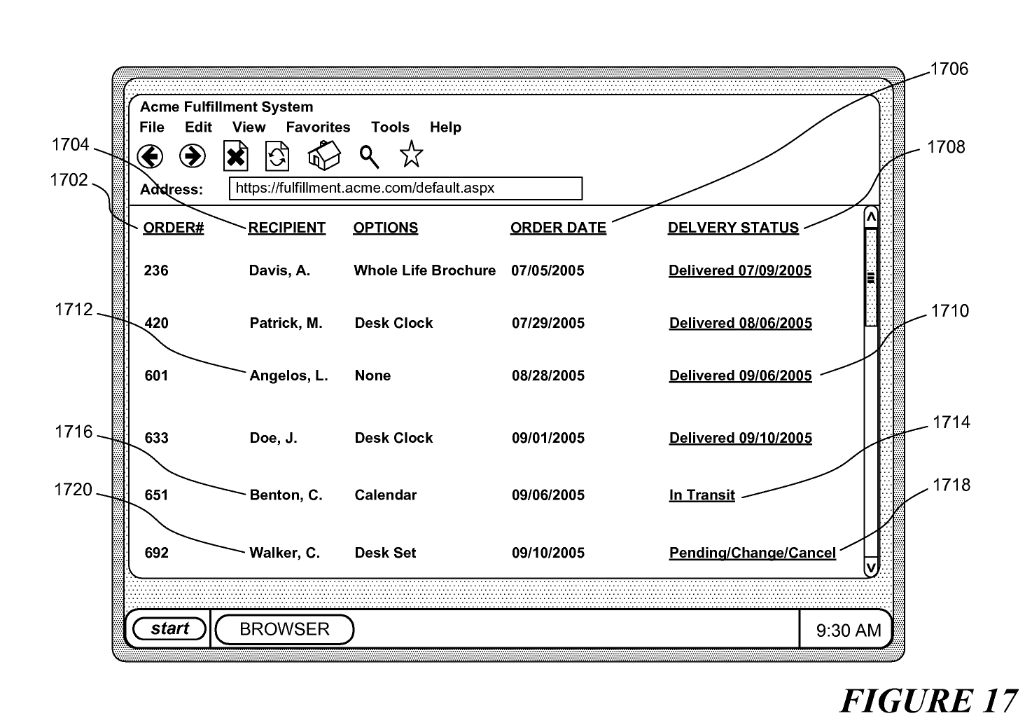

Referring back to FIG. 3, if it is determined at 308 that the user has selected the fulfillment request option 506 (FIG. 5) from the menu 504, at 310, the user is directed to fulfillment request processing. Fulfillment request processing is further described below in connection with FIGS. 6-11. Alternatively, if it is determined at 308 that the user has not selected the fulfillment request option 506 from the main menu 504, at 312 it is determined if the user has selected the order history option 508 from the main menu 504. If so, at 314, the user is directed to order history processing. Order history processing is further described below in connection with FIGS. 16 and 17.

Further alternatively, if it is determined at 312 that the user has not selected the order history option 508 (FIG. 5) from the main menu 504, at 316 it is determined if the user has selected the administrative functions 510 option. If so, at 318, the user is directed to administrative function processing. If it is determined at 316 that the user has not selected the administrative functions option 510 from the main menu 504, at 320 it is determined if the user has selected the help option 512. If so, at 322, the user is directed to order history processing. If it is determined at 320 that the user has not selected the help option 512 from the main menu 504, at 324 it is determined if the user has selected the logout option 514. If so, at 326, the user is logged out of the ICFM system. Further alternatively, if it is determined at 324 that the user has not selected the logout option 514 from the main menu 504, and thus has selected no options from the main menu 504, at 328, the user will be disconnected from the ICFM system after a predetermined timeout interval. The options described in this paragraph are well understood in the art.

Fulfillment Request Processing

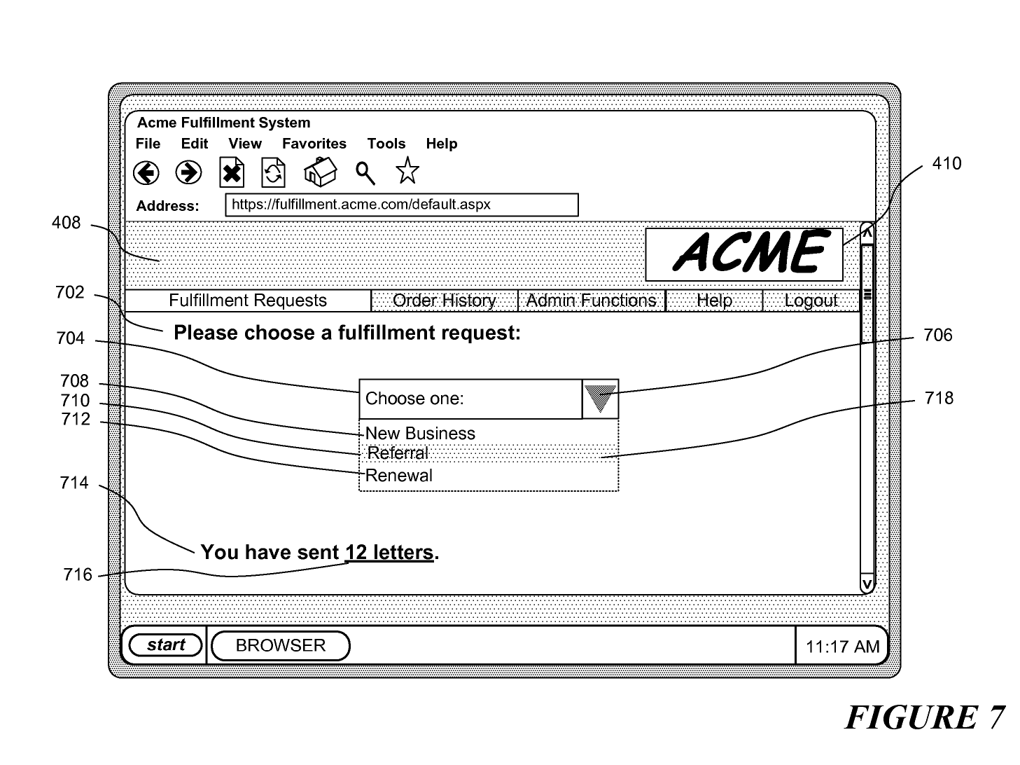

FIG. 6 is a flow diagram of a mode of an ICFM process 600 illustrating the logical steps of fulfillment request processing. The process 600 begins at 602, when the user selects fulfillment request processing from the main menu 504 (FIG. 5) as previously described. At 604, the user is provided a selection of possible fulfillment requests, as shown in FIG. 7.

FIG. 7 shows an exemplary fulfillment selection screen 700. Again, for the reasons described previously, the fulfillment request selection screen 700 includes a banner 408 presenting a logo 410 and colors used by the organization generally and/or on its own web pages, as do each of the fulfillment processing and order history screens described below.

Fulfillment selection screen 700 presents an instruction 702 directing the user to make a selection from drop-down menu 704. Drop-down menu 704 presents choices of different fulfillment requests available to the user upon selecting drop-down button 706. Different fulfillment requests available to the user in this example include options for “New Business” 708, “Referral” 710, and “Renewal” 712. Any number of different fulfillment request options may be listed in drop-down menu 704. In addition, instead of a drop-down menu 704, the options may be presented in a fixed menu with radio buttons, or using any other suitable input format. Fulfillment screen 700 also includes a cross-reference 714 to another aspect of an ICFM system that, in this case, is to the order history processing aspect of an ICFM system. A user can jump to this other aspect by selecting an underlined link 716, as is well understood in the art. From the exemplary fulfillment selection screen 700, the user selects a fulfillment request for a “Referral” 710, as indicated by the shaded box 718 highlighting the “Referral” 710 option.

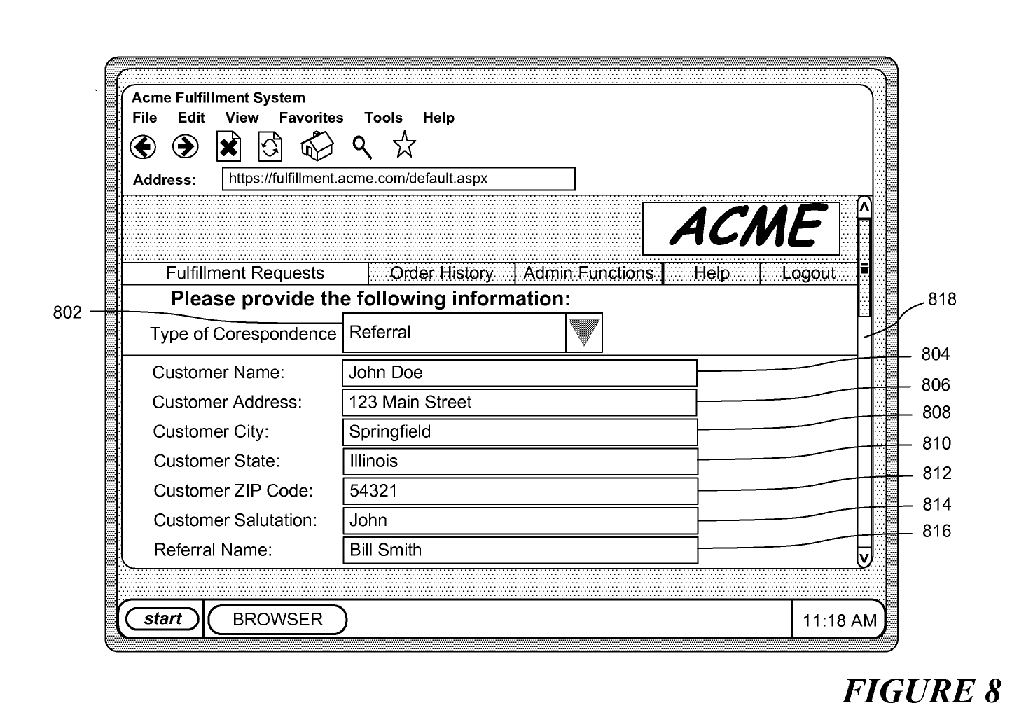

Referring back to FIG. 6, after presenting the fulfillment selection screen at 604, at 606, the fulfillment selection is received and it is determined what information should be collected to perform the fulfillment request. For example, for a fulfillment request related to new business 708 (FIG. 7), only the customer's name and address may be needed, whereas a fulfillment request related to a referral 712 also may require entry of the name of the person who was referred by the customer. Based on the information that is to be collected, at 608, an information entry screen is presented to collect information to be used in completing the fulfillment request, as shown in FIG. 8. According to one mode of an ICFM system, based on the type of fulfillment request selected by the user, XML processing is used in the creation of the information entry screen. More specifically, an XML-based definition of fields and input formats corresponding to the fulfillment request selected are converted into a hypertext markup language (HTML) input form into which the user input is received.

FIG. 8 shows an exemplary information entry screen 800. The information entry screen 800 presents a drop-down menu 802 specifying the fulfillment request selected from the fulfillment request selection screen 700 (FIG. 7). In one mode of an ICFM system, a user who has specified the wrong form of fulfillment request can use drop-down menu 802 to change the request and, as needed, modify the fields presented on the information entry screen 800 to gather information to complete the request. Information entry screen also includes a number of information entry fields, including a customer name field 804, a customer address field 806, a customer city field 808, a customer state field 810, a customer ZIP code field 812, a customer salutation 814, and a referral name 816. Using these fields, customized correspondence and envelopes and/or shipping labels needed to ship the fulfillment package are generated.

In addition to information that describes the customer, other information may be associated with the customer. For example, promotional information may be associated with the customer that identifies promotional activities to be undertaken for the recipient. This promotional information may include specifying contents of one or more predetermined fulfillment packages to be sent to the recipient as part of a marketing cycle. For example, a first fulfillment package may include literature about a good or service. A second fulfillment package may include additional literature or a gift that will be sent to the recipient if the recipient responded to the first fulfillment package. Thus, promotional information may also be associated with the customer to identify a program directing what fulfillment package or packages should be sent to a particular customer.

As previously mentioned, the information entry screen 800 is tailored to the type of fulfillment request specified in the drop-down menu 802. For example, if the fulfillment request were for new business 708 (FIG. 7) or a renewal 712, the name of a referral 816 would not be needed and would be omitted. On the other hand, fields for additional relevant information may be added. For example, if the business using the fulfillment system were involved in international trade, a field for country may be included to gather information needed to complete the fulfillment request.

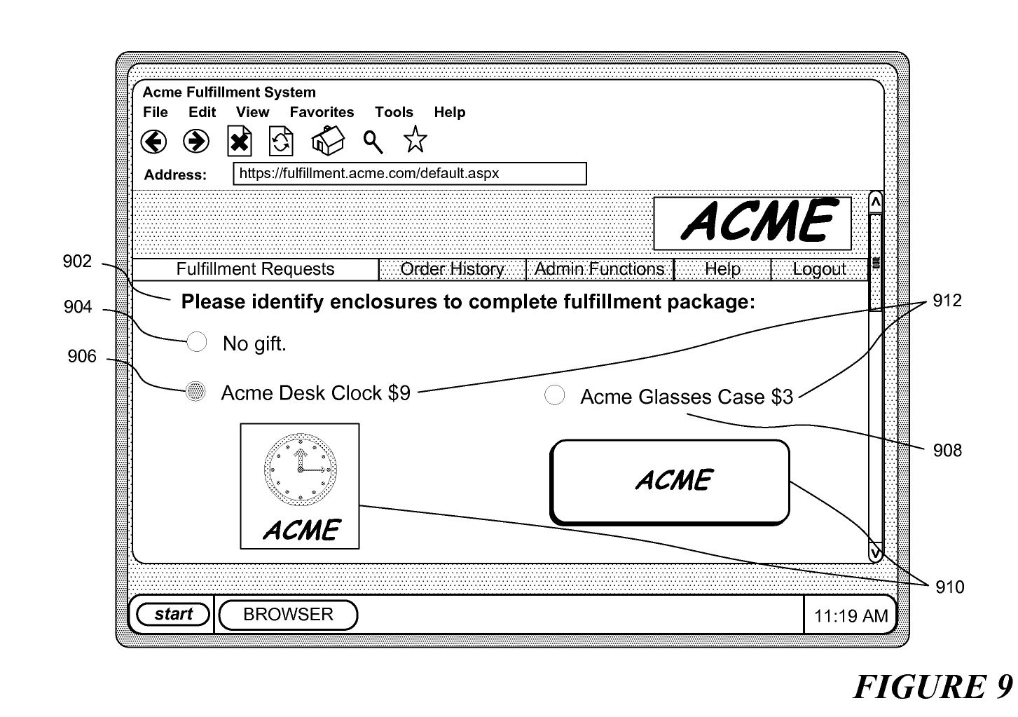

Referring back to FIG. 6, once needed information is collected using the information entry screen at 608, at 610, it is determined if enclosures, such as documents or articles, should be included in the fulfillment package by presenting an enclosure screen as shown in FIG. 9. The enclosure screen allows the user to identify whether brochures, customized literature, replacement parts, appreciation gifts, or other items should be included in the fulfillment package. As the information entry screen 700 (FIG. 7) is tailored to collect the appropriate information for the type of fulfillment requested, the enclosure screen also may be similarly tailored. Thus, for example, an enclosure screen responding to a product inquiry may present a selection of brochures about the product. Similarly, an enclosure screen for a renewal may present a brochure about loyal customer discounts for continued renewals and/or a list of appropriate gifts. On the other hand, the enclosure screen for a referral may present only a list of gifts, because marketing documents may be inappropriate in sending a gesture of appreciation.

FIG. 9 shows an exemplary tailored enclosure screen 900 for fulfillment request for a referral. The tailored enclosure screen 900 presents an instruction 902 to the user to direct the user to make a selection. The selections, as previously described, include a number of articles, such as appreciation gifts, that the user may wish to send a customer or client in appreciate for the referral. The user may select the no gift option 904. Alternatively, and as indicated in this example, the user may select the desk clock option 906, the eyeglass case option 908, or another option (not shown). In one mode of an ICFM system, images 910 of the enclosures are shown so that the user can see what they look like. Also, where the user is charged for fulfillment packages or has a monitored or limited fulfillment package budget, the prices 912 of the gifts or brochures (not shown) are presented to the user so that the user knows what each selection will cost.

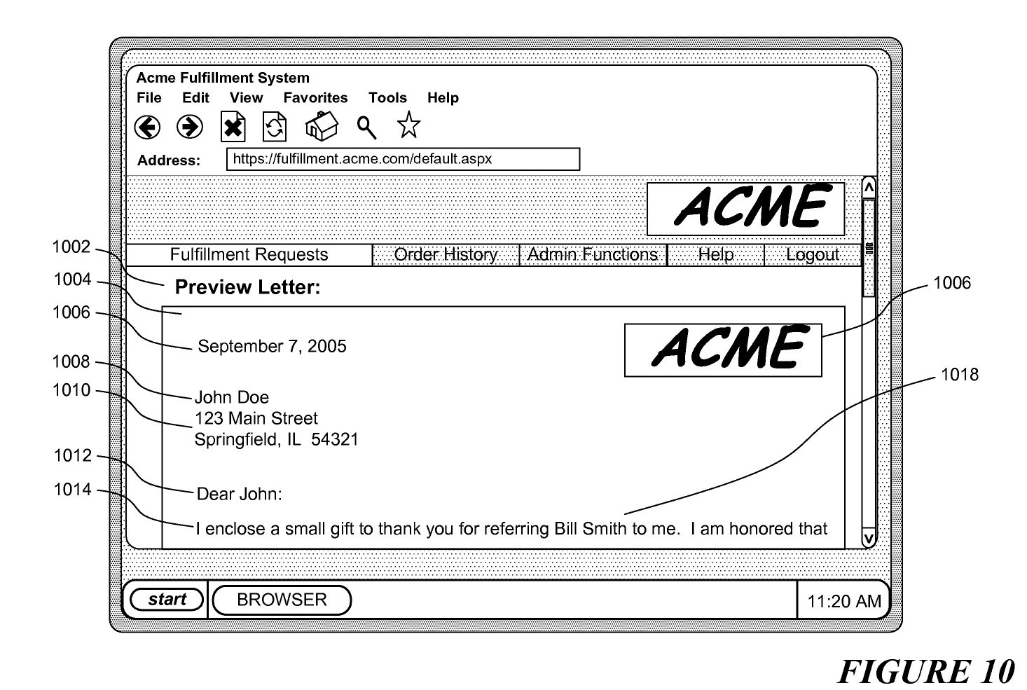

Referring back to FIG. 6, once a user has identified any enclosures to be included for the fulfillment package at 610, at 612 a preview of the customized correspondence is generated as shown in FIG. 10. Although, the correspondence preview may be generated before enclosures are selected, in one mode of an ICFM system it is desirable to generate the preview after enclosures are identified so that the enclosures may be referenced in the correspondence. For example, if a particular article or document is included, a template used to generate the correspondence may be adapted to name the document or article enclosed. At a minimum, when a user specifies that a document or article will be enclosed, the word “enclosure” may be appended to the correspondence. According to a mode of an ICFM system, based on the selection of one or more enclosures, the XML code blocks are manipulated to customize the correspondence accordingly.

FIG. 10 shows an exemplary correspondence preview screen 1000. Correspondence preview screen 1000 presents a preview message 1002 clarifying that the image of a letter 1004 is, in fact, a preview. The image includes the date of origination of the letter 1006 as well as information entered in the information entry screen 800 (FIG. 8) supplied by the user to customize the letter. More specifically, the image 1000 shows the recipient's name 1008 and address 1010, the salutation 1012, and the text of the letter 1014 and how they will appear in the letter. In one mode, the image 1004 also represents how information entered in the information entry screen 800 is inserted into text 1014, such as how the name of the referral 1016 appears in the text 1014.

In one mode of the ICFM system, the image 1004 is a what-you-see-is-what-you-get (WYSIWYG) image of the letter so that the user can proofread the information included in the letter and make sure the image 1004 indicates that the letter appears to be satisfactory. To that end, the image 1004 represents not only the content of the letter, but also shows how the letter will appear printed on letterhead 1018. In one mode of the ICFM system, one exception to the WYSIWYG image is that, instead of an image of a captured signature of the user that desirably will be imprinted on the letter, a designation “signature” (not shown) is included to protect the user from possible identity theft. At least, not using the image of the actual signature should give the user some assurance that the user's signature is protected from identity theft.

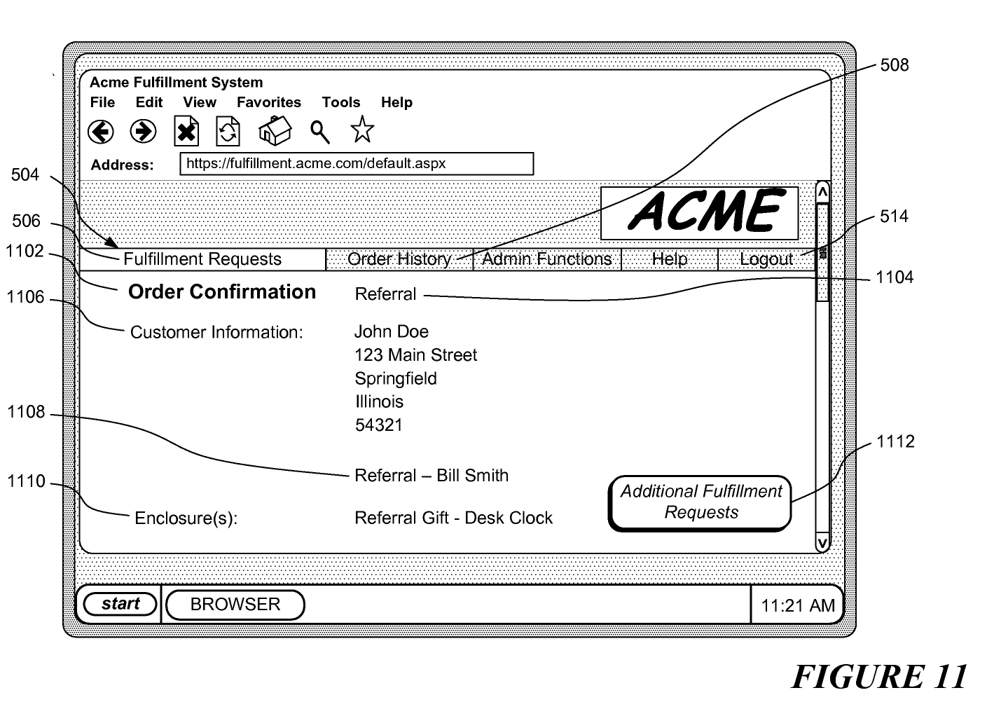

Referring back to FIG. 6, once the preview of the correspondence has been generated at 612, at 614 it is determined if any changes are desired by a user. If so, the process 600, in effect, reverts to 604, 606, and/or 608 to permit revisions to the fulfillment selection, information entry screen, or selected enclosures. According to one mode of ICFM, the user can use conventional browser back or history commands to retreat to the fulfillment request selection screen 700 (FIG. 7), the information entry screen 800 (FIG. 8), or the enclosure screen 900 (FIG. 9). Alternatively, the preview screen 1000 (FIG. 10) may include one or more revise options or on-screen buttons to facilitate revision of the elements the user wishes to change. On the other hand, if it is determined at 614 that no revisions are desired, at 616, a fulfillment order confirmation is generated as shown in FIG. 11.

FIG. 11 shows an exemplary order confirmation screen 1100. The order confirmation screen 1100 presents a confirmation message 1102 indicating that the screen 1100 is presented to confirm the fulfillment request 1104, the customer information 1106, additional information entered 1108 such as the referral name, and the enclosure or enclosures selected 1110. The order confirmation screen 1100, like the preview screen 1000 (FIG. 10) provides an additional confirmation as to the nature, contents, and enclosures of the fulfillment package, but also confirms that the fulfillment request has been submitted for processing.

Referring back to FIG. 6, once the order confirmation has been presented at 616, at 618, applicable chargebacks or debits to the user's account are calculated as a result of the fulfillment packages requested. Accordingly, the cost of supplies, documents, articles, postage, and other charges associated with fulfillment requests may be charged to the users requesting those packages. As a result, users will bear the costs of fulfillment packages they send or, alternatively, users can be restricted from exhausting more than their fair share of the budget and/or supplies allocated for fulfillment packages.

Once charges for a fulfillment request have been calculated for and/or attributed at 618, at 620, it is determined whether the user wishes to and is permitted to submit additional fulfillment requests. Once the chargebacks and/or debits are determined at 618, it may be determined that the user's budget or assigned inventory has been depleted and, thus, the user will not be permitted to submit additional requests. However, if the user is permitted to and wishes to submit additional requests, the process 600 loops back to 604. More specifically, referring to FIG. 11, if the user wishes to submit any additional fulfillment requests, the user selects the additional request option 1112 (FIG. 11). Alternatively, using the menu 504 (FIG. 5), the user may enter additional fulfillment requests by selecting the fulfillment request option 506 (FIG. 5). On the other hand, it may be determined at 620 that the user does not wish to submit additional fulfillment requests. The user may select the order history option 508, as is further described below, or the logout option 514 to terminate the session.

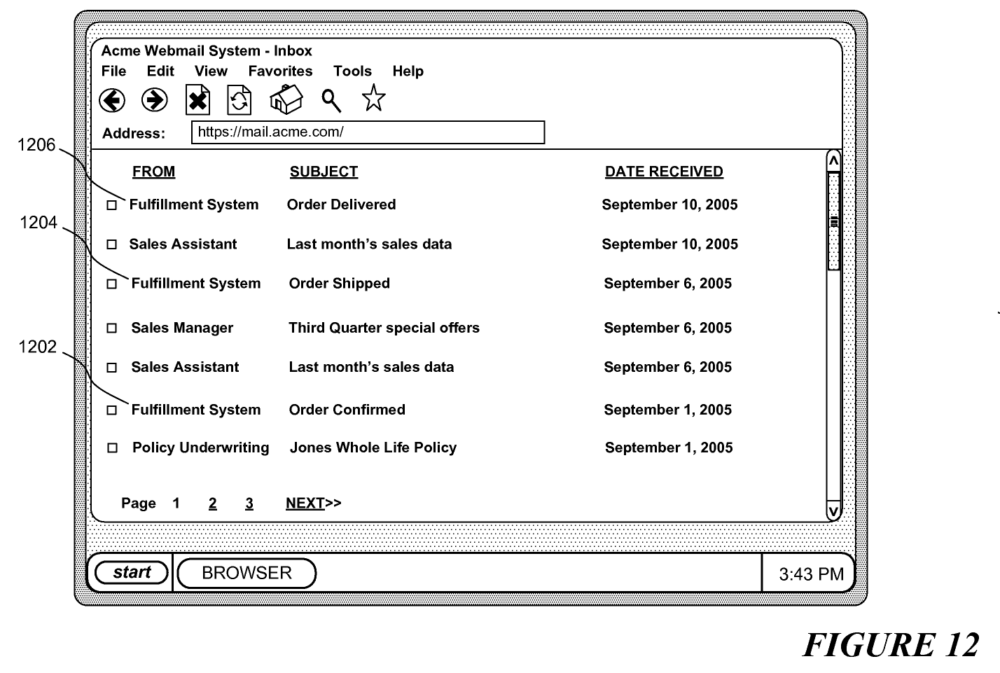

If it is determined at 620 that the user wishes to submit no further fulfillment requests at present, at 622, status messages are generated regarding the fulfillment requests. According to one mode of an ICFM system, the status messages are e-mail messages generated by the fulfillment host 108 (FIG. 1) based on information stored in a cache or database maintained by the fulfillment host 108 to keep the user apprised of the status of fulfillment packages requested by the user. Exemplary e-mail messages generated are shown in FIGS. 12-14. Alternatively, status messages may be generated in the form of XML code blocks presentable by a browser to allow the user to query the status of fulfillment packages, or in other forms.

FIG. 12 shows an e-mail inbox screen 1200 of a user of the ICFM system. As shown in FIG. 12, the e-mail inbox screen 1200 shows that, among other messages in the user's inbox, are message entries for messages generated by the fulfillment system, including an order confirmed message 1202, an order shipped message 1204, and an order delivered message 1206.

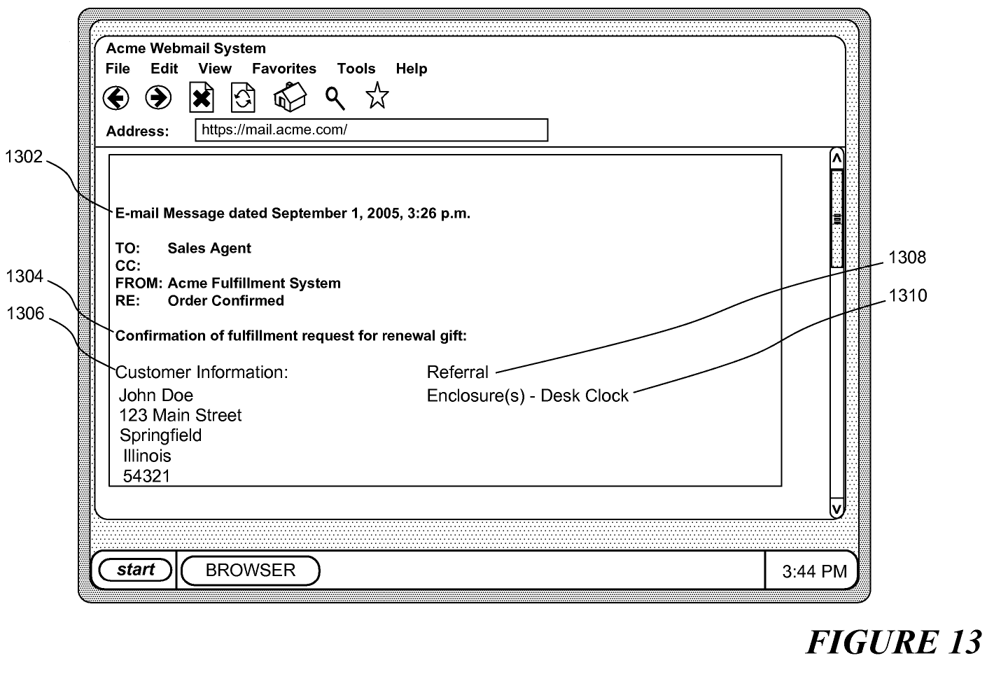

FIG. 13 displays an order confirmed message screen 1300 showing the contents of the order confirmed message 1202 (FIG. 12). More specifically, the e-mail shown in message screen 1300 confirms the fulfillment request submitted by the user as detailed in FIGS. 7-11. Thus, once the user has submitted a fulfillment request, the user not only is presented with the order confirmation screen 1100 (FIG. 11), but also receives this e-mail. Accordingly, the user receives an additional confirmation and record of the fulfillment request. Alternatively, if the user associated with the account from which the fulfillment request was submitted did not actually submit the request, the user receives notification of potential misuse of the user's account. The order confirmed message screen 1300 indicates the date and time of the confirmation 1302. Message screen 1300 also includes a confirmation indication 1304 that, in this case, confirms that a fulfillment request has been received. Message screen 1300 also reiterates and confirms the customer information 1306, the fulfillment type information 1308, and the enclosure information 1310 that, in this case, indicates that a deck clock was sent to the recipient.

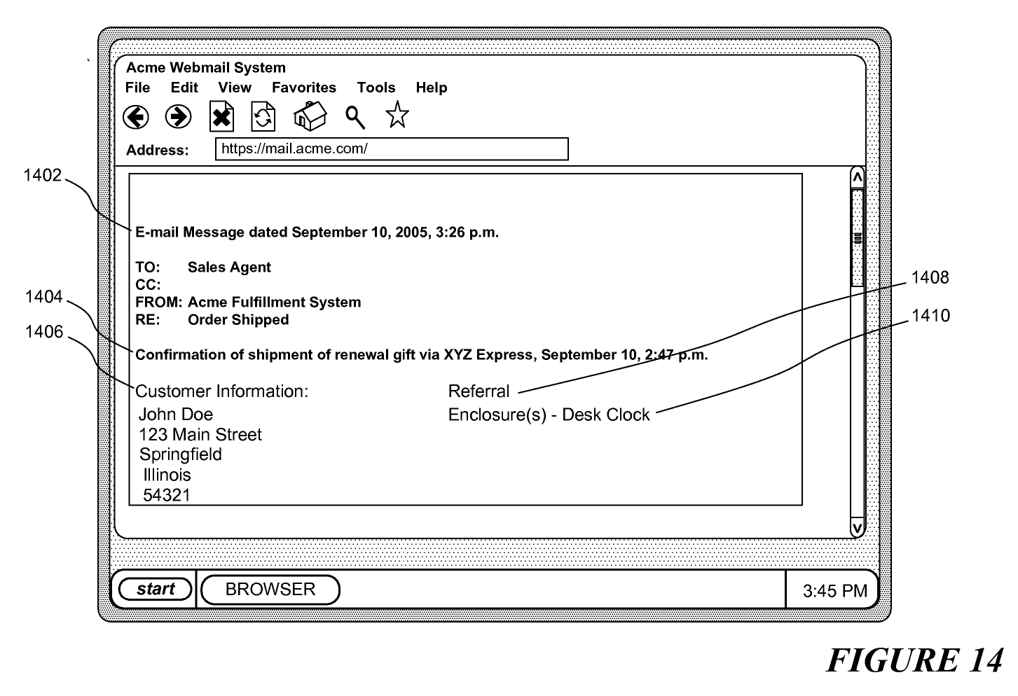

FIG. 14 displays an order shipped message screen 1400 showing the contents of the order shipped message 1204 (FIG. 12). More specifically, the e-mail shown in message screen 1300 confirms that a fulfillment package completing the user's fulfillment request has been shipped to the recipient. The order shipped message screen 1400 indicates the date and time of the confirmation 1402. Message screen 1400 also includes a confirmation indication 1404 that, in this case, confirms that the fulfillment package has been shipped from the fulfillment center. Message screen 1400 again reiterates and confirms the customer information 1406, the fulfillment type information 1408, and the enclosure information 1410. In addition, according to a mode of an ICFM system, the user's manager, assistant, partner, colleague, or another designated person may receive a copy of the confirmation message. The copy allows one or more additional persons to track the user's requests, help the user monitor his or her fulfillment requests, to help track fulfillment costs and budgets, and/or ensure that the user is discharging his or her customer fulfillment responsibilities.

Upon receiving the order shipped message 1400, the user does not have to wonder whether the fulfillment package the user requested has been sent. Further, knowing the fulfillment package is en route, the user can plan to contact the recipient as appropriate to determine if the recipient has questions, express thanks to the recipient, or initiate other appropriate communication. The order shipped message 1400 can be generated as a result of fulfillment personnel using the computer station 118 (FIG. 1) at the fulfillment center 112 indicating that the fulfillment package 122 has been sent. Alternatively, the order shipped message 1400 may be generated by the fulfillment host 108 based on a communication from the shipping host 130 that the fulfillment package 122 has been received by the shipping company. Further alternatively, an order shipped message 1400 may be generated by the shipping host 130 and sent directly to the user.

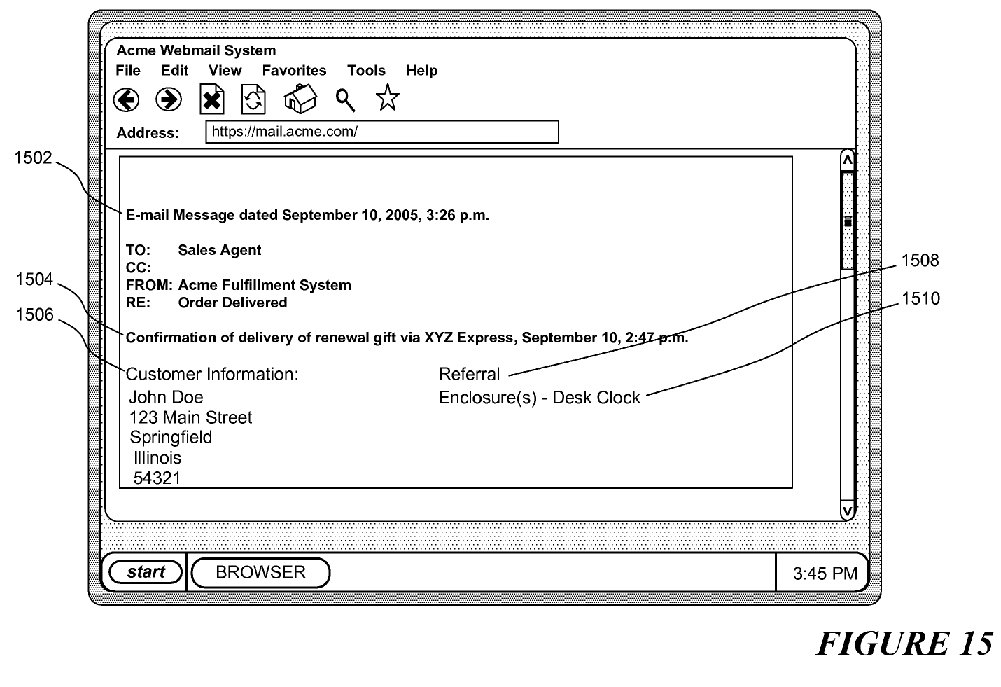

FIG. 15 displays an order delivered message screen 1500 showing the contents of the order shipped message 1206 (FIG. 12). More specifically, the e-mail shown in message screen 1400 confirms that a fulfillment package completing the user's fulfillment request has been delivered to the recipient. The order shipped message screen 1500 indicates the date and time of the confirmation 1502. Message screen 1500 also includes a confirmation indication 1504 that, in this case, confirms that the fulfillment package has been delivered to the recipient. Message screen 1500 again reiterates and confirms the customer information 1506, the fulfillment type information 1508, and the enclosure information 1510.

Upon receiving the order delivered message 1500, the user knows that the fulfillment package has been delivered to the recipient, and should contact the recipient. As in the case of the order shipped message 1400 (FIG. 14), the order delivered message 1500 may be generated by the fulfillment host 108 (FIG. 1) based on a communication from the shipping host 130 that the fulfillment package 122 has been delivered to the recipient. Alternatively, the order delivered message 1500 may generated by the shipping host 130 and sent directly to the user.

In sum, a user of an ICFM system, using his or her computer, can submit fulfillment requests for a customized fulfillment package, revise that package, and track the shipment and delivery of the fulfillment package.

Order History Processing

In addition to submitting and tracking new fulfillment requests, according to a mode of and ICFM system, the user can also track and, possibly, revise or cancel other fulfillment requests.

FIG. 16 is a flow diagram of a process 1600 illustrating the logical steps of order history processing using a mode of an ICFM system. Flow diagram 1600 begins at 1602, when the user selects order history processing from the main menu 504 (FIG. 5) as previously described. At 1604, the user is provided an order history of fulfillment requests processed for the user. The order history may include all fulfillment requests processed for the user, or the fulfillment requests processed over a predetermined period. According to one mode of an ICFM system, order history is presented in an order history report as shown in FIG. 17.

FIG. 17 shows an exemplary order history screen 1700. As previously described, in one mode of an ICFM system, the order history screen 1700 is a web page generated by a server or host in XML code blocks. The order history screen 1700 thus is accessible with a web browser. Alternatively, if an ICFM application is executing on a user station, the order history is retrieved from a server or host as data blocks interpretable by the application.

The order history screen 1700 lists a plurality of fulfillment events, including pending fulfillment requests, fulfillment packages in transit, and delivered fulfillment packages. Information in a number of categories, such as order number 1702, recipient 1704, order date 1706, delivery status 1708, and other elements of information are presented about each of the fulfillment events. According to a mode of an ICFM system, fulfillment events listed on the order history screen are sortable by selecting column headings for the different categories, as is well understood. At a glance, a user can review the status of fulfillment events.

The user may access additional information about the status of fulfillment events by, in one mode of an ICFM system, selecting entries for the delivery status 1708 of each fulfillment event. As shown in order history screen 1700, delivery status entries are underlined which signals that the entry is a link to another page, as is well understood in the art. Selecting one of the linked entries may retrieve data in the fulfillment host 108 (FIG. 1) or directly from the shipping host 130 regarding the delivery status of each fulfillment event. Thus, for example, by selecting entry 1710, the user may retrieve additional information about the delivery of the fulfillment package sent to “Angelos, L.” 1712. Similarly, by selecting entry 1714, the user may retrieve additional information about the shipping status of the fulfillment package sent to “Benton, C.” 1716. In addition, by selecting entry 1718, the user may be able to confirm—or change or cancel—the pending shipment to “Walker, C.” 1720.

Referring back to FIG. 16, once the order history is presented at 1604, at 1606 it is determined if a user selects a fulfillment event before a predetermined timeout. If not, the user will be disconnected at 1608. Alternatively, if it is determined that a user selects a fulfillment event at 1606, at 1610 it is determined if the user has selected an entry to obtain additional delivery or transit status about a fulfillment package. If so, at 1612, additional delivery information is presented to the user by retrieving the information or linking the user to a page where the information is presented. On the other hand, if it is determined at 1610 that the user has not selected delivery or shipping status information, at 1614, it is determined if the user has elected to change or cancel the order. If so, at 1616, the user is directed to fulfillment revision processing that can be implemented using fulfillment processing as previously described.

If the user has viewed delivery information at 1612 or performed fulfillment revision at 1616, or it is determined at 1606 and 1610 that the user has selected neither, at 1618 it is determined if the user has selected another event. If so, the process 1600 loops to 1606 to determine if an event is selected before a time out. If not, at 1620 it is determined if the user has selected to logout. If so, at 1622, the logout is processed. If not, at 1608, because the user has made no other selections, the user is disconnected.

Customer Relationship Management with Integrated Customer Fulfillment Management

An ICFM system may be integrated with a customer relationship manager (CRM) system to provide integrated customer relationship and fulfillment management. Combining an ICFM system and a CRM system adds the advantages of the customer tracking, database, and reporting capabilities of a CRM system with the advantages of an ICFM system as previously described. In addition, integrating the fulfillment event information generated by an ICFM system provides additional information that can be tracked and studied using the database and reporting capabilities of a CRM system, as well enhancing efficiency of sales tracking operations, facilitating personalization of fulfillment communications, and providing both visibility of and accountability for fulfillment requests.

CRM systems are supported by personal computers, host computers, and web servers. Alternatively, users can subscribe to CRM services accessible via a browser. An ICFM system may be coupled with all forms of CRM system. For purposes of the following description, the example of a web-accessible CRM subscription service is used. More specifically, according to one embodiment of a combined ICFM and CRM system, the ICFM system is transparently integrated with the CRM system such that users of a CRM system access ICFM functions through the CRM system. Thus, the user has the advantage of interacting with a single interface and a single system while reaping the advantages of both ICFM and CRM systems.

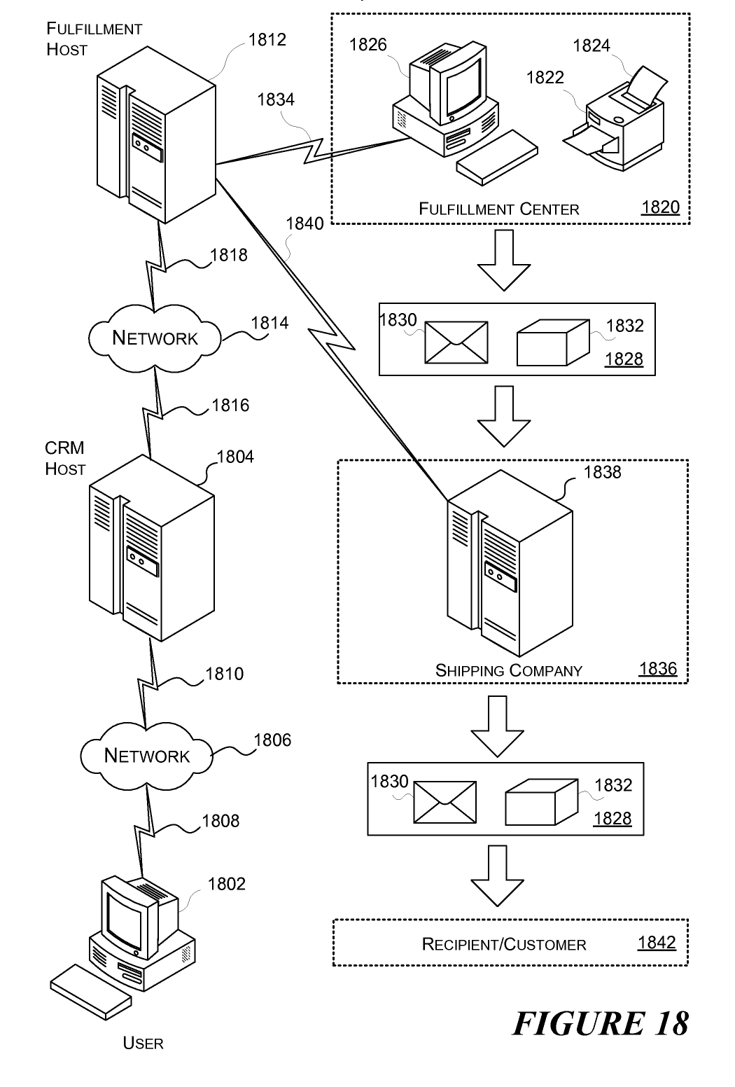

FIG. 18 illustrates aspects of a combined ICFM and CRM system 1800. A user (not shown) uses a user station 1802 to access the CRM system executing on a CRM host 1804. The user station 1802, as will be described further below in connection with FIG. 25, may include a personal computer, such as desktop computer, laptop computer, handheld computer, a terminal, or a similar device that allows the user to access CRM. The user station 1802 is coupled to a network 1806, such as a local area network (LAN), or a wide area network (WAN) such as the Internet or another WAN, via a communications link 1808. In turn, the network 1806 communicates with the CRM host 1804 via an additional communications link 1810. The CRM host 1804 may be a personal computer, a server, a mainframe computer, or a group of such computers. The communications links 1808 and 1810 may be dial-up, Ethernet, broadband, wireless, or other forms of communication providing data communications. To name one example described further below, a user may access a CRM running on the CRM host 1804 from a web browser executing on the user station 1802.

Once a user engages the CRM executing on the CRM host 1804, the CRM host 1804 processes the CRM transactions. When a user invokes ICFM functions, the CRM host 1804 engages the fulfillment host 1812. The CRM host engages the ICFM host over a network 1814 over a communications link 1816. The network 1814, in turn, engages the fulfillment host 1812 over an additional communications link 1818. The network 1814 and the communications links 1816 and 1818 may be embodied in a number of forms as previously described.

It should be noted that the CRM host 1804 and the fulfillment host 1812 may be combined into a single system, and the CRM and ICFM systems may be combined into a single, integrated instruction set. Separate systems allow for the prospect of the CRM system being on independent service and the ICFM system being another independent service, operated by different organizations. Alternatively, within a large organization, it may be logical for the CRM host 1804 and the fulfillment host 1812 to be combined in a single system.

Further alternatively, it may be desirable to permit direct communication between the user station 1802 and the fulfillment host 1812, for example, by passing messages and data between network 1806 and network 1814 to which the user station 1802 and the fulfillment host 1812, respectively, are connected. It should be appreciated that networks 1806 and 1814 also may be the same network, such as a WAN like the Internet through which some or all of the devices in the combined ICFM and CRM system 1800 may communicate. With a direct communications link between the user station 1802 and the fulfillment host 1812, when fulfillment functions are requested, for example, the CRM host 1804 may pass control to the fulfillment host 1812. The CRM host 1804 may then retake control of the session once fulfillment functions are completed.

Once a user submits a fulfillment request to the fulfillment host 1812 via the CRM host 1804, the fulfillment host 1812 processes the fulfillment transaction and issues a fulfillment order to a fulfillment center 1820. As previously described in connection with FIG. 1, the fulfillment requests and orders may be stored in a cache or a database to facilitate aggregate processing of orders for a particular client and/or to allow fulfillment personnel to efficiently manage fulfillment scheduling and workflow.

The fulfillment center 1820, in one mode of combined CRM and ICFM systems, includes a printer 1822 that is used to generate documents 1824 including picking orders, correspondence, and customized literature, and a computer station 1826 where processing of the fulfillment orders are confirmed. In one mode of combined CRM and ICFM systems, issuance by the fulfillment host 1812 of the fulfillment order results in a picking order being generated as a document 1824 at the fulfillment center 1820. The picking order may specify which letterhead and how much should be loaded into the printer 1822 for generation of correspondence and any customized literature, and indicate whether a selected article or selected articles are to be included in the fulfillment package. Using the picking order, fulfillment personnel can process the fulfillment order and prepare fulfillment package 1828, consisting of correspondence 1830 and one or more enclosures 1832.

Fulfillment personnel use the computer station 1826, which may be a personal computer, a terminal, or another device permitting access to the ICFM application on the fulfillment host 1812, to signal when a fulfillment package has been prepared for shipment, or if there is a reason the fulfillment package cannot be sent. Alternatively, the picking order may be presented on the computer station 1826 rather than in document form. The fulfillment station 1820, including the printer 1822 and the computer station 1826 are in communication with the fulfillment host 1812 via a communications link 1834. The communications link 1834 may employ dial-up, Ethernet, broadband, wireless, or other form of communication providing data communications with the fulfillment host 1812.

It should be noted that the fulfillment host 1812 might reside at the fulfillment center 1820, which also may be combined with the CRM host 1804 as described previously. Thus, the fulfillment host 1812 and the computer station 1826 may be the same computing device. Alternatively, there may be multiple fulfillment centers 1820 located at different geographic locations to serve customers in that geographic location or because fulfillment supplies are available in that particular geographic location. Further, a fulfillment center 1820 may receive fulfillment orders from multiple fulfillment hosts 1812.

Once a fulfillment package 1828 has been prepared, the fulfillment package is shipped using a shipping company 1836. Fulfillment personnel may deliver a fulfillment package 1828 to the shipping company 1836 or, using the computer station 1826 or another means of communication, fulfillment personnel at the fulfillment center 1820 inform the shipping company 1836 of one or more fulfillment packages 1828 that are ready to be shipped. Once logged for shipment with or delivered to the shipping company 1836, a shipping host 1838 is used to track the delivery status of the fulfillment package 1828. In one mode, the shipping host 1838 communicates with the fulfillment host 1812 via a communications link 1840. The communications link 1840 may include a dedicated line or be part of a WAN (not shown) such as the Internet, as previously described, over which data records are exchanged between the systems.

The fulfillment host 1812 may query the shipping host 1838 for updates on the status of fulfillment packages 1832 logged in the fulfillment host 1812. Alternatively, the shipping host 1838 may send updates to the fulfillment host 1812 periodically or when specific events occur, such as the delivery of a fulfillment package 1838 to a recipient or customer 1842. Further alternatively, the shipping host 1838 may send updates in the form of e-mail messages to the fulfillment host 1812, the CRM host 1804, or directly to a user so that the user may receive the updates at the user station 1808 or via another computing system.

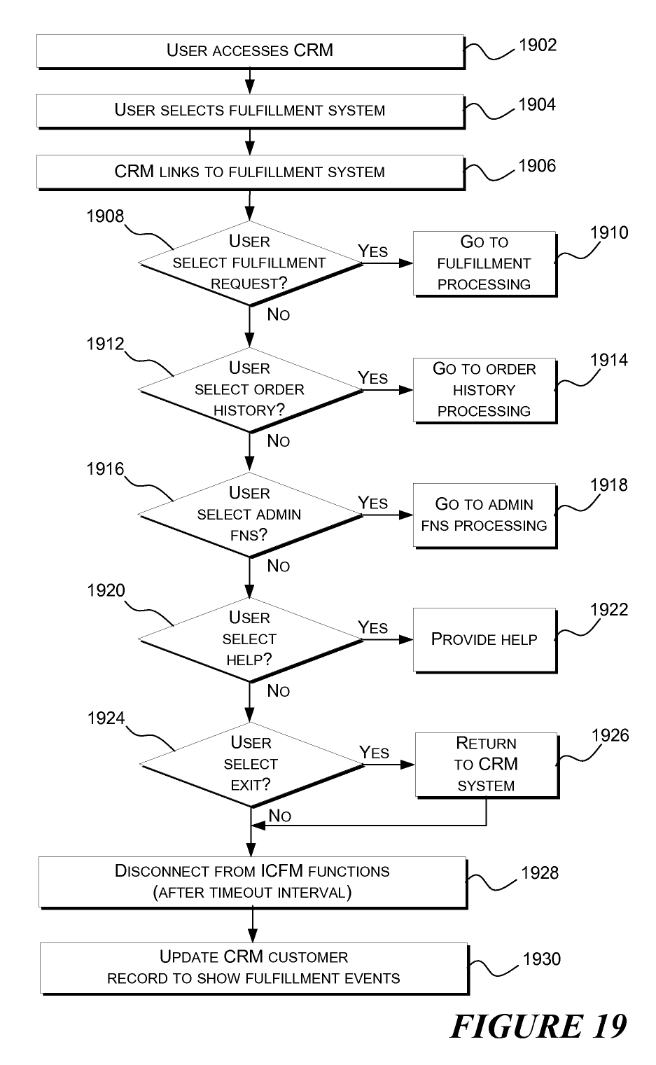

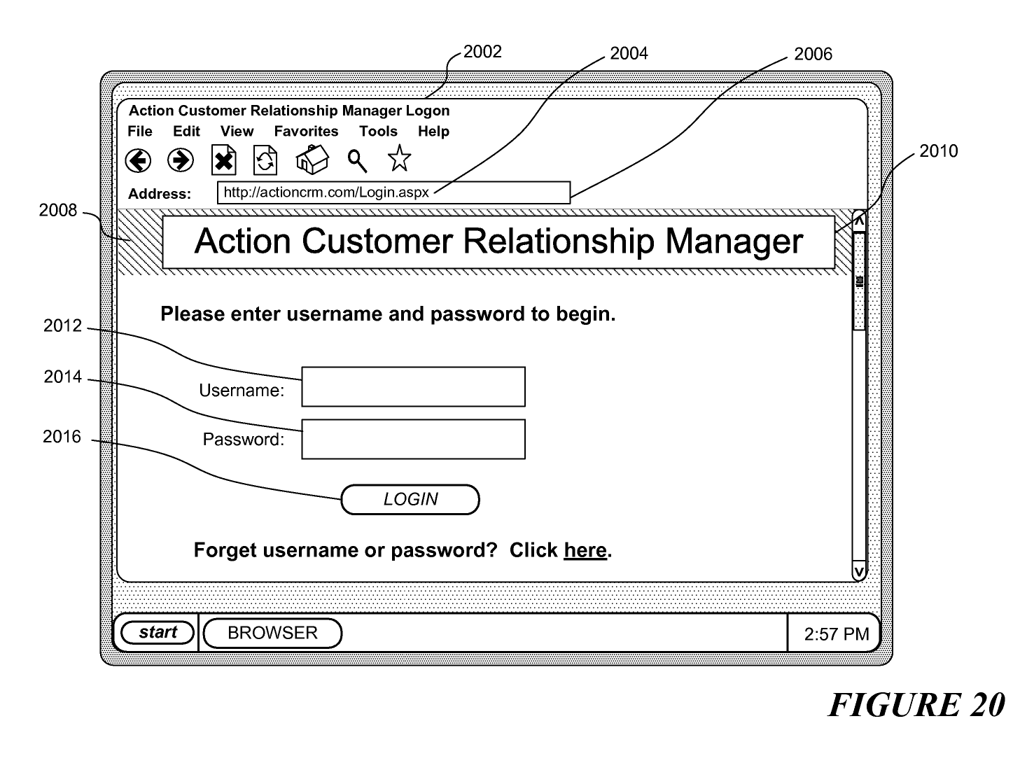

FIG. 19 includes a flow diagram of a process 1900 summarizing a mode of combined CRM and ICFM systems. At 1902, a user accesses the CRM via an interface such as that shown in FIG. 20.

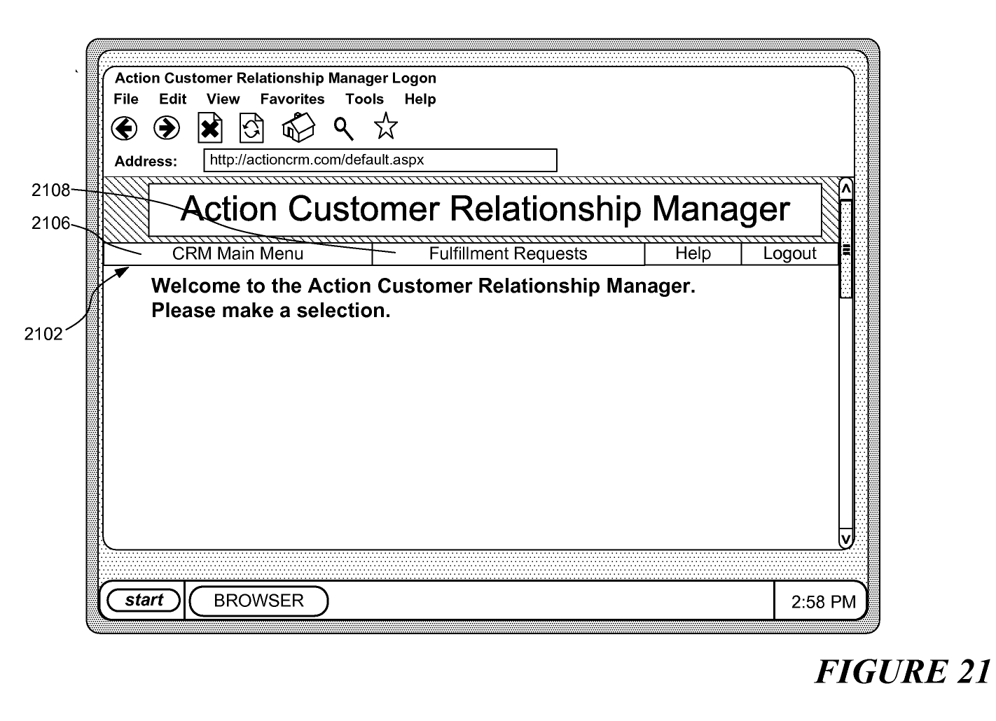

FIG. 20 shows a CRM interface screen 2000 for the “Action Customer Relationship Manager” which, for purposes of this example, is a subscription-based CRM service. The CRM service is accessed via a browser application window 2002. As in the case of many subscription-based CRM systems, a user accesses the CRM service by entering a URL 2004 of the CRM service in an address field 2006. The interface screen 2000 includes a banner 2008 presenting the logo 2010 and colors of the CRM service. A user accesses the CRM service by entering a username and a password in a username field 2012 and a password field 2014, respectively, and selecting a login button 2016 or pressing an enter key on a keyboard. Assuming the logon is successful, the user is able to access a CRM service main menu screen as shown in FIG. 21

FIG. 21 shows an exemplary CRM main menu screen 2100. The main menu screen 2100 allows the user to select functions from a main menu 2102. The menu 2102 includes a plurality of options represented on-screen “buttons” selectable by a cursor. The menu 2102 includes a CRM main menu option 2106 and a fulfillment requests option 2108 among other options. The CRM main menu option 2106 allows the user to engage customer relationship management functions. The fulfillment requests option 2108 allows the user to engage the types of ICFM functions previously described in connection with FIGS. 3-11.

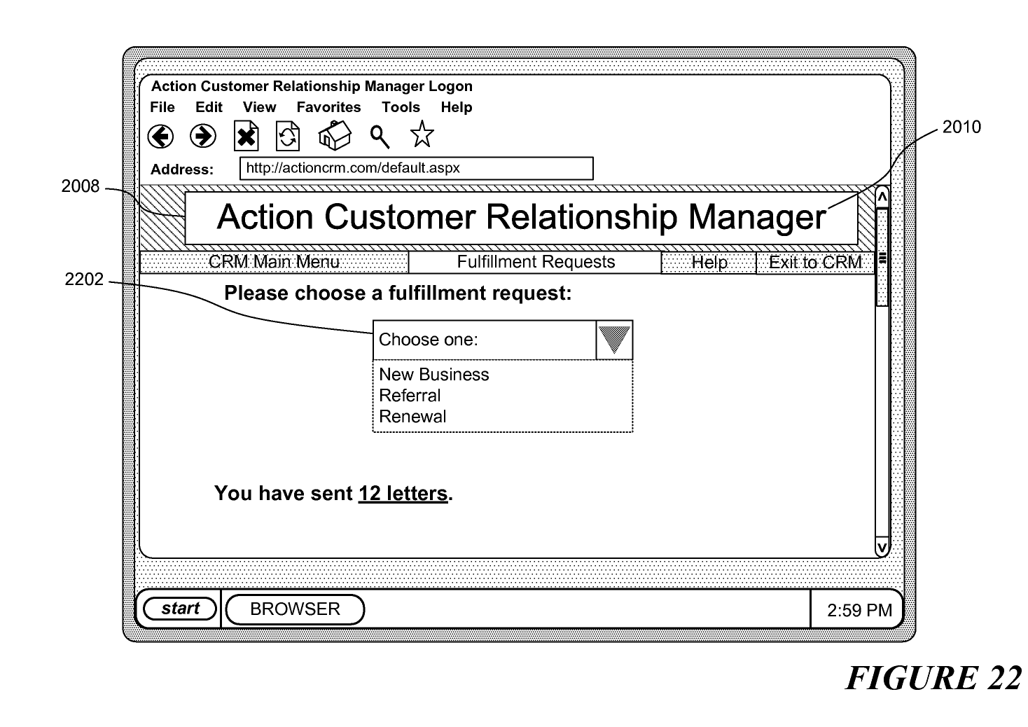

Referring back to FIG. 19, at 1904, if the user selects the fulfillment system by selecting the fulfillment request option 2108 (FIG. 21), at 1906, the CRM links to the fulfillment system. According to one mode of combined CRM and ICFM, a user engages the fulfillment system through the CRM interface so that the fulfillment system is transparent to the user, as shown in FIG. 22.

FIG. 22 shows a CRM fulfillment options interface 2200. Again, the CRM fulfillment options interface 2200 includes the banner 2008 and the logo 2010 used on other screens in the CRM. However, instead of present CRM functions, the CRM fulfillment options interface 2200 presents a drop-down menu 2202 identical to that presented in the ICFM interface screen described in connection with FIG. 7. As also previously described, the ICFM functions may be implemented with XML code blocks that can be combined with XML code blocks or other code blocks used to present the CRM interface to present a unified, seamless, interface.

Referring back to FIG. 19, once the CRM links to the fulfillment system at 1906, the functions performed by the ICFM through the CRM are comparable to those previously described in connection with a separate ICFM system. At 1908, it is determined if the user has selected a fulfillment request. If so, at 1910, the ICFM system initiates fulfillment processing as previously described. If not, at 1912 it is determined if the user has selected order history functions. If so, at 1914, the ICFM system initiates order history processing. Alternatively, according to one mode of a combined ICFM and CRM system, CRM facilities can be used to track order processing, and the ICFM system need not include its own order history processing.

If it is determined at 1912 that the user has not selected to perform order history processing, at 1916, it is determined if user has selected administrative functions. If so, at 1918, the ICFM system initiates administrative functions processing. If not, at 1920 it is determined if the user has selected help functions. If so, at 1922, the ICFM system provides help to the user. If not, at 1924, it is determined if the user has selected to exit to CRM functions. If so, at 1926, the ICFM system returns control to the CRM system. If not, at 1928, after a timeout interval has passed, the user is disconnected from the ICFM system whether or not the user has elected to exit the ICFM system. At 1930, CRM records are updated to record new fulfillment events or fulfillment event changes. As a result, the CRM reporting and analysis functions are available to analyze the effectiveness of fulfillment efforts.

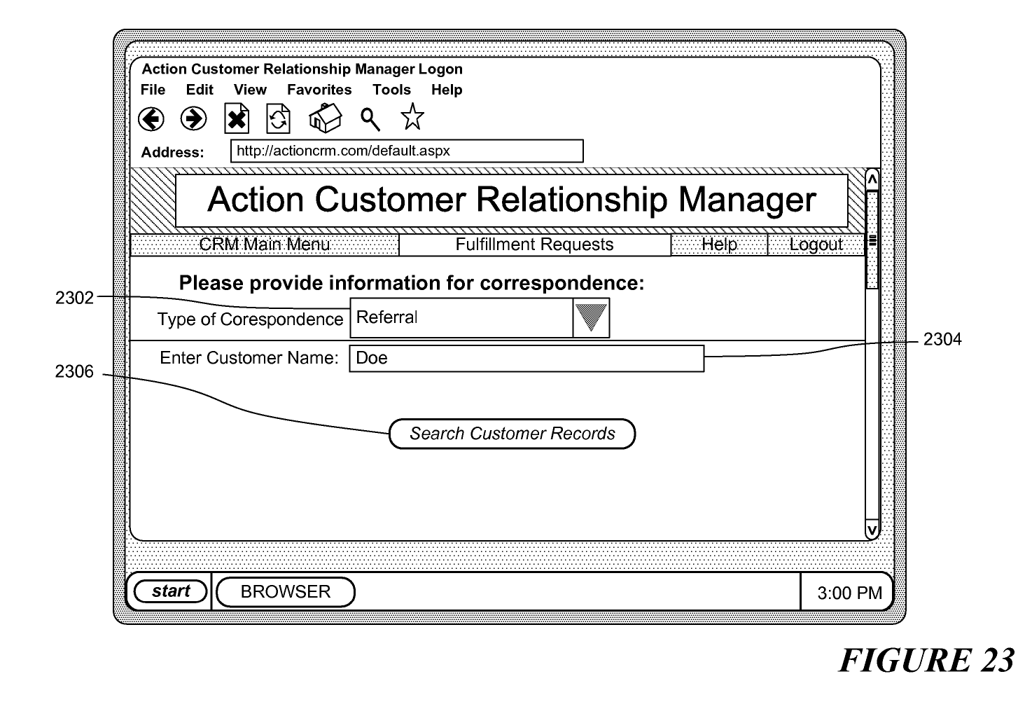

FIG. 23 shows an information entry screen 2300 illustrating an advantage of an ICFM system coupled with a CRM system. Information entry screen 2300, in addition to providing a drop-down menu 2302 allowing the user to choose a fulfillment option, presents a customer name field 2304. With comparison to the information entry screen 800 (FIG. 8), in which the user keyed all the customer information, an ICFM system coupled with a CRM system provides automatic retrieval of customer information stored in the CRM. Thus, instead of keying the customer information into the fields as listed in entry screen 800, in information entry screen 2300, the user enters a customer name into the customer name field 2304 and selects a search button 2306. The customer name search retrieves the information about the customer and uses the information to populate the information fields.

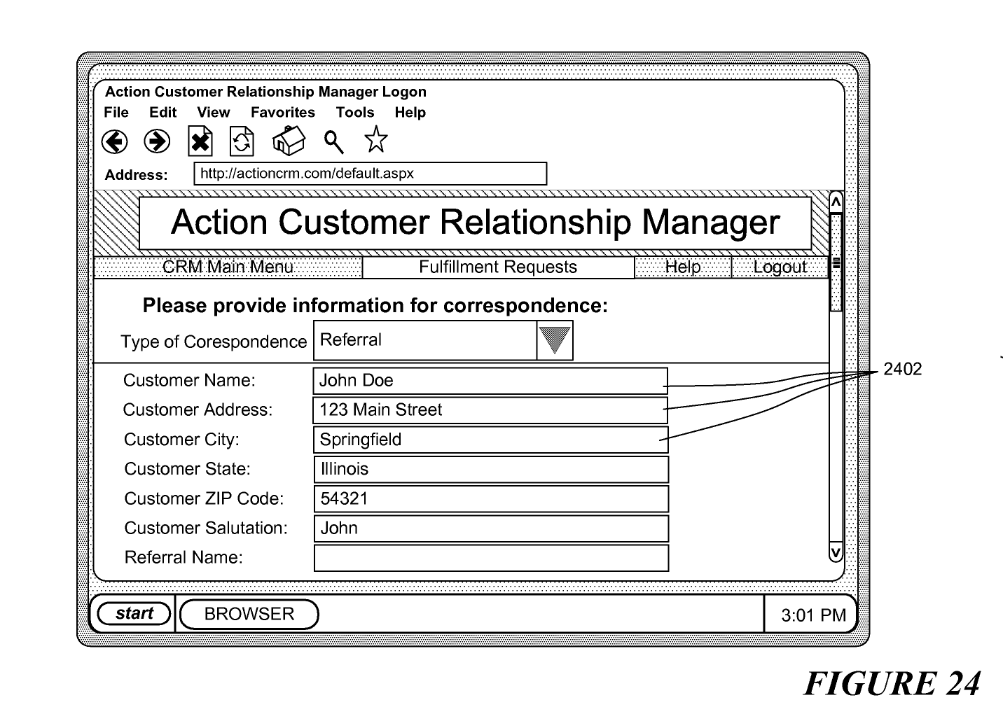

FIG. 24 shows an information entry screen 2400 in which the fields 2402 are populated with the retrieved customer information. Thus, in a combined ICFM and CRM system, the process of submitting fulfillment requests is even more simple.

Computing System for Implementing Embodiments of an ICFM System

FIG. 25 illustrates an exemplary computing system 2500 for implementing the ICFM system, whether or not it is integrated with a CRM system. The computing system 2500 is only one example of a suitable operating environment for an embodiment of the present invention and is not intended to suggest any limitation as to the scope of use or functionality of the invention. Neither should the computing system 2500 be interpreted as having any dependency or requirement relating to any one or combination of components illustrated in the exemplary operating environment 2500. In addition, as previously described, portions of the system may reside on separate computing systems, and multiple computing systems may be used to create an archive to support the ICFM system. Thus, multiple computing systems as described in FIG. 25 may be used in implementing embodiments of the ICFM system.

Embodiments may be described in the general context of computer-executable instructions, such as program modules, being executed on computing system 2500. Generally, program modules include routines, programs, objects, components, data structures, etc., that perform particular tasks or implement particular abstract data types. Moreover, those skilled in the art will appreciate that embodiments may be practiced with a variety of computer-system configurations, including hand-held devices, multiprocessor systems, microprocessor-based or programmable-consumer electronics, minicomputers, mainframe computers, and the like.

With reference to FIG. 25, an exemplary computing system 2500 includes a computer 2510 including a processing unit 2520, a system memory 2530, and a system bus 2521 that couples various system components including the system memory 2530 to the processing unit 2520.

Computer 2510 typically includes a variety of computer-readable media. By way of example, and not limitation, computer-readable media may comprise computer-storage media and communication media. Examples of computer-storage media include, but are not limited to, Random Access Memory (RAM); Read Only Memory (ROM); Electronically Erasable Programmable Read Only Memory (EEPROM); flash memory or other memory technology; CD ROM, digital versatile discs (DVD) or other optical or holographic disc storage; magnetic cassettes, magnetic tape, magnetic disk storage or other magnetic storage devices; or any other medium that can be used to store desired information and be accessed by computer 2510. The system memory 2530 includes computer-storage media in the form of volatile and/or nonvolatile memory such as ROM 2531 and RAM 2532. A Basic Input/Output System 2533 (BIOS), containing the basic routines that help to transfer information between elements within computer 2510 (such as during start-up) is typically stored in ROM 2531. RAM 2532 typically contains data and/or program modules that are immediately accessible to and/or presently being operated on by processing unit 2520. By way of example, and not limitation, FIG. 25 illustrates operating system 2534, application programs 2535, other program modules 2536, and program data 2537.

The computer 2510 may also include other removable/nonremovable, volatile/nonvolatile computer-storage media. By way of example only, FIG. 25 illustrates a hard disk drive 2541 that reads from or writes to nonremovable, nonvolatile magnetic media, a magnetic disk drive 2551 that reads from or writes to a removable, nonvolatile magnetic disk 2552, and an optical-disc drive 2555 that reads from or writes to a removable, nonvolatile optical disc 2556 such as a CD-ROM or other optical media. Other removable/nonremovable, volatile/nonvolatile computer-storage media that can be used in the exemplary operating environment include, but are not limited to, magnetic tape cassettes, flash memory units, digital versatile discs, digital video tape, solid state RAM, solid state ROM, and the like. The hard disk drive 2541 is typically connected to the system bus 2521 through a nonremovable memory interface such as interface 2540. Magnetic disk drive 2551 and optical dick drive 2555 are typically connected to the system bus 2521 by a removable memory interface, such as interface 2550.

The drives and their associated computer-storage media discussed above and illustrated in FIG. 25 provide storage of computer-readable instructions, data structures, program modules and other data for computer 2510. For example, hard disk drive 2541 is illustrated as storing operating system 2544, application programs 2545, other program modules 2546, and program data 2547. Note that these components can either be the same as or different from operating system 2534, application programs 2535, other program modules 2536, and program data 2537. Typically, the operating system, application programs, and the like that are stored in RAM are portions of the corresponding systems, programs, or data read from hard disk drive 2541, the portions varying in size and scope depending on the functions desired. Operating system 2544, application programs 2545, other program modules 2546, and program data 2547 are given different numbers here to illustrate that, at a minimum, they can be different copies. A user may enter commands and information into the computer 2510 through input devices such as a keyboard 2562; pointing device 2561, commonly referred to as a mouse, trackball or touch pad; a wireless-input-reception component 2563; or a wireless source such as a remote control. Other input devices (not shown) may include a microphone, joystick, game pad, satellite dish, scanner, or the like. These and other input devices are often connected to the processing unit 2520 through a user-input interface 2560 that is coupled to the system bus 2521 but may be connected by other interface and bus structures, such as a parallel port, game port, IEEE 1394 port, or a universal serial bus (USB) 2598, or infrared (IR) bus 2599. As previously mentioned, input/output functions can be facilitated in a distributed manner via a communications network.

A display device 2591 is also connected to the system bus 2521 via an interface, such as a video interface 2590. Display device 2591 can be any device to display the output of computer 2510 not limited to a monitor, an LCD screen, a TFT screen, a flat-panel display, a conventional television, or screen projector. In addition to the display device 2591, computers may also include other peripheral output devices such as speakers 2597 and printer 2596, which may be connected through an output peripheral interface 2595.

The computer 2510 is configured to operate in a networked environment using logical connections to one or more remote computers, such as a remote computer 2580. The remote computer 2580 may be a personal computer, and typically includes many or all of the elements described above relative to the computer 2510, although only a memory storage device 2581 has been illustrated in FIG. 25. The logical connections depicted in FIG. 25 include a local-area network (LAN) 2571 and a wide-area network (WAN) 2573 but may also include other networks, such as connections to a metropolitan-area network (MAN), intranet, or the Internet.

When used in a LAN networking environment, the computer 2510 is connected to the LAN 2571 through a network interface or adapter 2570. When used in a WAN networking environment, the computer 2510 typically includes a modem 2572 or other means for establishing communications over the WAN 2573, such as the Internet. The modem 2572, which may be internal or external, may be connected to the system bus 2521 via the network interface 2570, or other appropriate mechanism. Modem 2572 could be a cable modem, DSL modem, or other broadband device. In a networked environment, program modules depicted relative to the computer 2510, or portions thereof, may be stored in the remote memory storage device. By way of example, and not limitation, FIG. 25 illustrates remote application programs 2585 as residing on memory device 2581. It will be appreciated that the network connections shown are exemplary, and other means of establishing a communications link between the computers may be used.

Although many other internal components of the computer 2510 are not shown, those of ordinary skill in the art will appreciate that such components and the interconnections are well known. For example, including various expansion cards such as television-tuner cards and network-interface cards within a computer 2510 is conventional. Accordingly, additional details concerning the internal construction of the computer 2510 are widely understood.

When the computer 2510 is turned on or reset, the BIOS 2533, which is stored in ROM 2531, instructs the processing unit 2520 to load the operating system, or necessary portion thereof, from the hard disk drive 2541 into the RAM 2532. Once the copied portion of the operating system, designated as operating system 2544, is loaded into RAM 2532, the processing unit 2520 executes the operating system code and causes the visual elements associated with the user interface of the operating system 2534 to be displayed on the display device 2591. Typically, when an application program 2545 is opened by a user, the program code and relevant data are read from the hard disk drive 2541 and the necessary portions are copied into RAM 2532, the copied portion represented herein by reference numeral 2535.

### CONCLUSION

Although embodiments of an ICFM method and system have described in language specific to structural features and/or methodological acts, it is to be understood that the appended claims are not necessarily limited to the specific features or acts described. Rather, the specific features and acts are disclosed as exemplary forms of implementing embodiments of the ICFM system and method.

1. A method implemented by at least one computing system, comprising:
receiving computer-readable data representing a fulfillment request including:
identification of a recipient for a fulfillment package;
selection of content of the fulfillment package, the fulfillment package including a communication personalized to the recipient, and allowing an option to include with the letter at least one of:
a document, including at least one of an electronic document and a physical document; and
an article for the recipient; and
directing the computer-readable data representing the fulfillment request via a communications network to a fulfillment center for preparation of the fulfillment package, the fulfillment center having the capabilities of:
accessing a database including personal information about the recipient;
extracting at least a portion of the personal information about the recipient to include in the letter; and
describing the content of the fulfillment package.

2. A method of claim 1, wherein the identifying of the recipient includes at least one of:
entering the personal information about the recipient; and
selecting a recipient record from the database including the personal information about the recipient.

3. A method of claim 2, wherein the database is one of:
maintained by on a computing system under control of an enterprise with whom a person requesting the fulfillment package or on whose behalf the fulfillment package is requested is affiliated; and
maintained by a third-party.

4. A method of claim 3, wherein the database is part of a customer relationship management system.

5. A method of claim 4, wherein the information about the fulfillment package is one of stored in or accessible by the customer relationship management system.

6. A method of claim 1, wherein the personal information about the recipient further includes at least one of:
a recipient name;
a recipient address;
a recipient e-mail address;
a recipient title;
a recipient salutation;
a name of at least one additional person associated with the recipient;
a designation of an occasion motivating the fulfillment request;
a name of a person requesting the fulfillment package or on whose behalf the fulfillment package is requested;
a signature of the person requesting the fulfillment package or on whose behalf the fulfillment package is requested; and
promotion information identifying actions to be undertaken for the recipient including specifying contents of at least one predetermined fulfillment package to be sent to the recipient.

7. A method of claim 1, wherein the fulfillment center has the further capability of at least one of:
maintaining an inventory of letterhead for generating a personalized letter;
generating letterhead appropriate for generating the personalized letter;
maintaining an inventory of the documents;
being able to generate the documents;
being able to at least one of generate and maintain a personalized e-mail;
being able to at least one of generate and maintain a personalized web page;
maintaining an inventory of the article; and
being able to access a supply of the article.

8. A method of claim 1, wherein the article includes a gift item bearing identifying information including at least one of:
a name of a person requesting the fulfillment package or on whose behalf the fulfillment package is requested; and
an enterprise associated with the person requesting the fulfillment package or on whose behalf the fulfillment package is requested.

9. A method of claim 1, further comprising presenting a preview of the personalized letter, wherein the personalized letter can be accepted, rejected or modified.

10. A method of claim 1, further comprising causing information about the fulfillment package to be made available to at least one of:
a name of a person requesting the fulfillment package or on whose behalf the fulfillment package is requested;
an enterprise associated with the person requesting the fulfillment package or on whose behalf the fulfillment package is requested;
at least one additional person authorized to monitor the information; and
storing the information about the fulfillment package in the database.

11. A method of claim 10, wherein the information about the fulfillment package is made available by at least one of:
an e-mail message; and
a report retrievable upon request.

12. A method of claim 1, wherein the information about the fulfillment package includes at least one of a date and a time of:
completion of the fulfillment request;
completion of the preparation of the fulfillment package;
shipping of the fulfillment package from the fulfillment center;
arrival or departure of the fulfillment package at locations through which the fulfillment package is shipped; and
receipt of the fulfillment package by the recipient.

13. A method of claim 1, further comprising allowing cancellation of a shipment of a fulfillment package.

14. A method of claim 1, further comprising attributing a cost of the fulfillment package to one of:
a name of a person requesting the fulfillment package or on whose behalf the fulfillment package is requested;
an enterprise with whom the person requesting the fulfillment package or on whose behalf the fulfillment package is requested is affiliated; and
a department within the enterprise with whom the person requesting the fulfillment package or on whose behalf the fulfillment package is requested is affiliated.

15. A method of claim 1, wherein the fulfillment center is operated by one of:
an enterprise with whom a person requesting the fulfillment package or on whose behalf the fulfillment package is requested is affiliated; and
a third party fulfillment service provider with whom the enterprise or the person requesting the fulfillment package or on whose behalf the fulfillment package is requested is affiliated and the enterprise is affiliated.

16. A computer-readable medium having computer-useable instructions embodied thereon for executing the method of claim 1

17. A method implemented by at least one computing system, comprising:
receiving a fulfillment request including:
identification of a recipient for a fulfillment package;
selection of content of the fulfillment package, the fulfillment package including a communication personalized to the recipient regarding an actual or a potential purchase by at least one of the recipient and a third party and allowing an option to include of at least one of:
a document, including at least one of an electronic document and a physical document regarding a good or a service for which the recipient is a potential customer; and
a physical item for the recipient acknowledging the actual or the potential purchase;
directing the fulfillment request to a fulfillment center for preparation of the fulfillment package, the fulfillment center having the capabilities of:
accessing personal information about the recipient;
using the information in preparing the fulfillment package; and
facilitating shipment of the fulfillment package;
attributing a cost of the fulfillment package to one of an individual and an organization on whose behalf the fulfillment package is requested; and
causing information about the fulfillment package to be maintained for use in at least one of monitoring the cost of the fulfillment package and determining a possible effect on the recipient of the fulfillment package.

18. A method of claim 17, wherein the personal information about the recipient and the information about the fulfillment package are maintained in a customer relationship manager database.

19. A system comprising one or more computers programmed to perform actions comprising:
receiving a fulfillment request including:
identification of a recipient for a fulfillment package;
selection of content of the fulfillment package, the fulfillment package including a communication personalized to the recipient and allowing an option to include of at least one of:
a document, including at least one of an electronic document and a physical document; and
an article;
directing the fulfillment request to a fulfillment center for preparation of the fulfillment package including the communication and at least one of the document and the article, the fulfillment center having the capabilities of:
accessing personal information about the recipient;
using the personal information in preparing the fulfillment package; and
facilitating shipment of the fulfillment package; and
causing information about content and status of the fulfillment package to be maintained.

20. The system of claim 19, wherein the system includes a fulfillment system configured to receive and direct the fulfillment requests and at least one of:
a customer relationship management interface configured to receive and maintain personal information about the recipient from a customer relationship management system; and
a shipping information interface configured to receive shipping information describing the shipment, transit, and delivery of the fulfillment package from a shipping information system used to ship the fulfillment package.
